(19) United States
(12) Patent Application Publication
(10) Pub. No.: US 2021/0136770 A1
(43) Pub. Date: May 6, 2021

(54) TERMINAL APPARATUS, BASE STATION APPARATUS, AND COMMUNICATION METHOD

(71) Applicants: Sharp Kabushiki Kaisha, Sakai City, Osaka (JP); FG Innovation Company Limited, New Territories (HK)

(72) Inventors: Daiichiro NAKASHIMA, Sakai City (JP); Tomoki YOSHIMURA, Sakai City (JP); Taewoo LEE, Sakai City (JP); Shoichi SUZUKI, Sakai City (JP); Liqing LIU, Sakai City (JP); Wataru OUCHI, Sakai City (JP)

(21) Appl. No.: 16/638,782

(22) PCT Filed: Jul. 31, 2018
(86) PCT No.: PCT/JP2018/028644

§ 371 Date: Feb. 13, 2020

(30) Foreign Application Priority Data
Sep. 7, 2017 (JP) 2017-172155

(51) Int. Cl. H04W 72/04; H04W 24/08

(52) U.S. Cl. CPC H04W 72/0493; H04W 72/042; H04W 24/08; H04W 72/0453; H04W 72/0446

(57) ABSTRACT

A first PDCCH and a second PDCCH are received in a first cell, the first PDCCH including resource allocation information for a PDSCH of the first cell, the second PDCCH including resource allocation information for a PDSCH of a second cell, and a receiver configured to monitor one or more first PDCCH candidates and one or more second PDCCH candidates in a control resource set and a decoding unit configured to decode a first PDCCH candidate of the one or more first PDCCH candidates and a second PDCCH candidate of the one or more second PDCCH candidates are included, wherein the second PDCCH candidate with a first aggregation level includes multiple CCEs that are shifted, based on a carrier indicator, relative to multiple CCEs constituting the first PDCCH candidate with the first aggregation level, and the second PDCCH candidate with a second aggregation level includes one or more CCEs among the multiple CCEs constituting the second PDCCH candidate with the first aggregation level.

### TECHNICAL FIELD

The present invention relates to a terminal apparatus, a base station apparatus, and a communication method.

This application claims priority based on JP 2017-172155 filed on Sep. 7, 2017, the contents of which are incorporated herein by reference.

### BACKGROUND ART

In the 3rd Generation Partnership Project (3GPP), the specifications have been drafted for a radio access method and a radio network for cellular mobile communications (hereinafter referred to as “Long Term Evolution (LTE)”or “Evolved Universal Terrestrial Radio Access (EUTRA)”). In LTE, a base station apparatus is also referred to as an evolved NodeB (eNodeB), and a terminal apparatus is also referred to as User Equipment (UE). LTE is a cellular communication system in which multiple areas are deployed in a cellular structure, with each of the multiple areas being covered by a base station apparatus. A single base station apparatus may manage multiple cells.

In the 3GPP, for proposal to International Mobile Telecommunication (IMT)-2020, which is a standard for next-generation mobile communication system developed by the International Telecommunications Union (ITU), a next-generation standard (New Radio (NR)) has been studied (NPL 1). The NR has been requested to meet requirements assuming three scenarios: enhanced Mobile BroadBand (eMBB), massive Machine Type Communication (mMTC), and Ultra Reliable and Low Latency Communication (URLLC) in a single technology framework.

### CITATION LIST

### Non Patent Literature

NPL 1: “New SID proposal: Study on New Radio Access Technology,” RP-160671, NTT docomo, 3GPP TSG RAN Meeting #71, Goteborg, Sweden, 7th-10th Mar. 2016.

### SUMMARY OF INVENTION

### Technical Problem

One aspect of the present invention provides a terminal apparatus capable of efficiently performing downlink reception, a communication method used for the terminal apparatus, a base station apparatus capable of efficiently performing downlink transmission, and a communication method used for the base station apparatus.

### Solution to Problem

(1) A first aspect of the present invention is a terminal apparatus that receives a first PDCCH and a second PDCCH in a first cell, the first PDCCH including resource allocation information for a PDSCH of the first cell, the second PDCCH including resource allocation information for a PDSCH of a second cell, the terminal apparatus including: a receiver configured to monitor one or more first PDCCH candidates and one or more second PDCCH candidates in a control resource set; and a decoding unit configured to decode a first PDCCH candidate of the one or more first PDCCH candidates and a second PDCCH candidate of the one or more second PDCCH candidates, wherein the second PDCCH candidate with a first aggregation level includes multiple CCEs that are shifted, based on a carrier indicator, relative to multiple CCEs constituting the first PDCCH candidate with the first aggregation level, and the second PDCCH candidate with a second aggregation level includes one or more CCEs among the multiple CCEs constituting the second PDCCH candidate with the first aggregation level.

(2) A second aspect of the present invention is a communication method used for a terminal apparatus that receives a first PDCCH and a second PDCCH in a first cell, the first PDCCH including resource allocation information for a PDSCH of the first cell, the second PDCCH including resource allocation information for a PDSCH of a second cell, the communication method including the steps of: monitoring one or more first PDCCH candidates and one or more second PDCCH candidates in a control resource set; and decoding a first PDCCH candidate of the one or more first PDCCH candidates and a second PDCCH candidate of the one or more second PDCCH candidates, wherein the second PDCCH candidate with a first aggregation level includes multiple CCEs that are shifted, based on a carrier indicator, relative to multiple CCEs constituting the first PDCCH candidate with the first aggregation level, and the second PDCCH candidate with a second aggregation level includes one or more CCEs among the multiple CCEs constituting the second PDCCH candidate with the first aggregation level.

(3) A third aspect of the present invention is a base station apparatus that transmits a first PDCCH and a second PDCCH on a first cell, the first PDCCH including resource allocation information for a PDSCH of the first cell, the second PDCCH including resource allocation information for a PDSCH of a second cell, the base station apparatus including: a USS grasp unit configured to grasp one or more first PDCCH candidates and one or more second PDCCH candidates in a control resource set, the control resource set being configured as a Search space for a terminal apparatus; and a transmitter configured to transmit the first PDCCH by using a first PDCCH candidate of the one or more first PDCCH candidates and transmit the second PDCCH by using a second PDCCH candidate of the one or more second PDCCH candidates, wherein the second PDCCH candidate with a first aggregation level includes multiple CCEs that are shifted, based on a carrier indicator, relative to multiple CCEs constituting the first PDCCH candidate with the first aggregation level, and the second PDCCH candidate with a second aggregation level includes one or more CCEs among the multiple CCEs constituting the second PDCCH candidate with the first aggregation level.

(4) A fourth aspect of the present invention is a communication method used for a base station apparatus that transmits a first PDCCH and a second PDCCH in a first cell, the first PDCCH including resource allocation information for a PDSCH of the first cell, the second PDCCH including resource allocation information for a PDSCH of a second cell, the communication method including the steps of: grasping one or more first PDCCH candidates and one or more second PDCCH candidates in a control resource set, the control resource set being configured as a Search space for a terminal apparatus; and transmitting the first PDCCH by using a first PDCCH of the one or more first PDCCH candidates and transmitting the second PDCCH by using a second PDCCH of the one or more second PDCCH candidates, wherein the second PDCCH candidate with a first aggregation level includes multiple CCEs that are shifted, based on a carrier indicator, relative to multiple CCEs constituting the first PDCCH candidate with the first aggregation level, and the second PDCCH candidate with a second aggregation level includes one or more CCEs among the multiple CCEs constituting the second PDCCH candidate with the first aggregation level.

### Advantageous Effects of Invention

According to one aspect of the present invention, the terminal apparatus can efficiently perform downlink reception. In addition, the base station apparatus can efficiently perform downlink transmission.

### BRIEF DESCRIPTION OF DRAWINGS

FIG. 1 is a conceptual diagram of a radio communication system according to one aspect of the present embodiment.

FIG. 2 is an example illustrating configurations of a radio frame, subframes, and slots according to one aspect of the present embodiment.

FIG. 3 is a diagram illustrating a configuration example of the slots and mini-slots according to one aspect of the present embodiment.

FIG. 4 is a diagram illustrating an example of mapping control resource sets according to one aspect of the present embodiment.

FIG. 5 is a diagram illustrating an example of resource elements included in the slot according to one aspect of the present embodiment.

FIG. 6 is a diagram illustrating an example of a configuration of one REG according to one aspect of the present embodiment.

FIG. 7 is a diagram illustrating a configuration example of CCEs according to one aspect of the present embodiment.

FIG. 8 is a diagram illustrating an example of a relationship between the number of REGs constituting an REG group and a mapping method of a PDCCH candidate according to one aspect of the present embodiment.

FIG. 9 is a diagram illustrating an example of mapping of REGs constituting the CCE according to one aspect of the present embodiment.

FIG. 10 is a schematic block diagram illustrating a configuration of a terminal apparatus 1 according to the present embodiment.

FIG. 11 is a schematic block diagram illustrating a configuration of a base station apparatus 3 according to the present embodiment.

FIG. 12 is a diagram illustrating an example of a first initial connection procedure (4-step contention based RACH procedure) according to one aspect of the present embodiment.

FIG. 13 is a diagram illustrating an example of a PDCCH candidate monitored by the terminal apparatus 1 according to one aspect of the present embodiment.

FIG. 14 is a diagram illustrating an example of allocation of a slot (first slot format)-based control resource set according to one aspect of the present embodiment.

FIG. 15 is a diagram illustrating an example of allocation of a non-slot (second slot format)-based control resource set according to one aspect of the present embodiment.

FIG. 16 is a diagram illustrating an example of PDCCH candidates constituting a USS according to an embodiment of the present invention.

FIG. 17 is a diagram illustrating an example of PDCCH candidates constituting a USS according to an embodiment of the present invention.

FIG. 18 is a diagram illustrating an example of PDCCH candidates constituting a USS according to an embodiment of the present invention.

### DESCRIPTION OF EMBODIMENTS

Embodiments of the present invention will be described below.

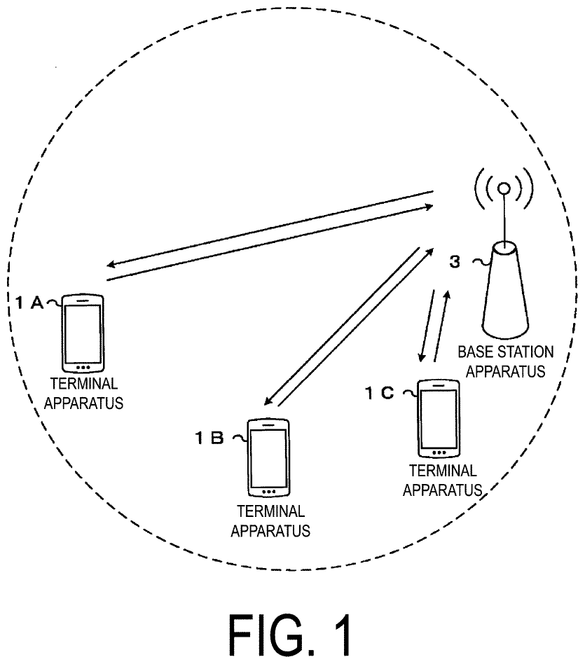

FIG. 1 is a conceptual diagram of a radio communication system according to one aspect of the present embodiment. In FIG. 1, a radio communication system includes terminal apparatuses 1A to 1C and a base station apparatus 3 (gNB). Hereinafter, the terminal apparatuses 1A to 1C are also referred to terminal apparatuses 1 (UE).

Hereinafter, various radio parameters related to communications between the terminal apparatus 1 and the base station apparatus 3 will be described. Here, at least some of the radio parameters (for example, Subcarrier Spacing (SCS)) are also referred to as Numerology. The radio parameters include at least some of the subcarrier spacing, a length of an OFDM symbol, a length of a subframe, a length of a slot, or a length of a mini-slot.

The subcarrier spacing may be classified into two: reference subcarrier spacing (Reference SCS, Reference Numerology) and subcarrier spacing (Actual SCS, Actual Numerology) for a communication method used for the actual radio communications. The reference subcarrier spacing may be used to determine at least some of the radio parameters. For example, the reference subcarrier spacing is used to configure the length of the subframe. Here, the reference subcarrier spacing is, for example, 15 kHz.

The subcarrier spacing used for the actual radio communications is one of the radio parameters for the communication method (for example, Orthogonal Frequency Division Multiplex (OFDM), Orthogonal Frequency Division Multiple Access (OFDMA), Single Carrier-Frequency Division Multiple Access (SC-FDMA), Discrete Fourier Transform-spread-OFDM (DFT-s-OFDM) used for radio communication between the terminal apparatus 1 and the base station apparatus 3. Hereinafter, the reference subcarrier spacing is also referred to as a first subcarrier spacing. The subcarrier spacing used for the actual radio communications is also referred to as a second subcarrier spacing.

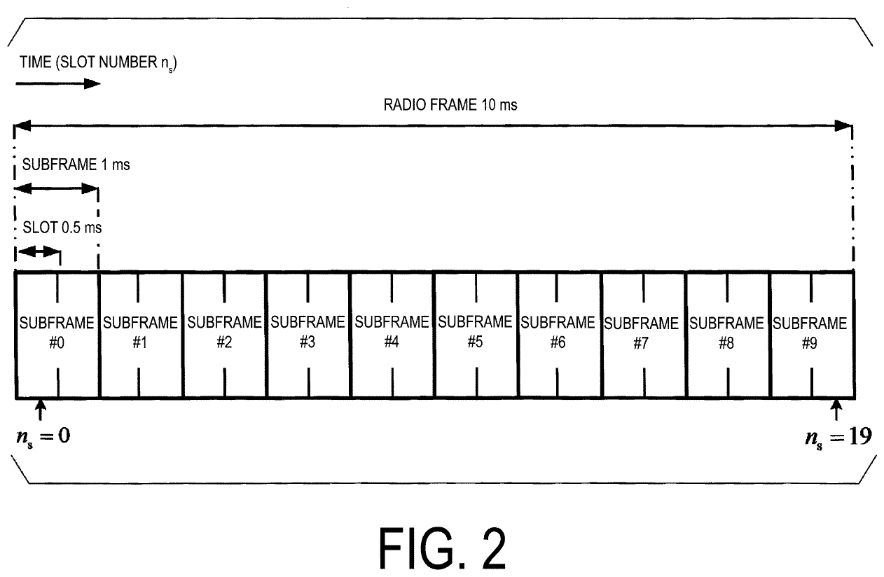

FIG. 2 is an example illustrating configurations of a radio frame, subframes, and slots according to one aspect of the present embodiment. In one example illustrated in FIG. 2, the length of the slot is 0.5 ms, the length of the subframe is 1 ms, and the length of the radio frame is 10 ms. The slot may be a unit for resource allocation in the time domain. For example, the slot may be a unit for mapping of one transport block. For example, the transport block may be mapped to one slot. Here, the transport block may be a unit of data to be transmitted in a prescribed interval (for example, Transmission Time Interval (TTI)) defined in a higher layer (for example, Mediam Access Control (MAC), Radio Resource Control (RRC)).

For example, the length of the slot may be given according to the number of OFDM symbols. For example, the number of OFDM symbols may be 7 or 14. The length of the slot may be given based on at least the length of the OFDM symbol. The length of the OFDM symbol may differ based on at least the second subcarrier spacing. The length of the OFDM symbol may be given based on at least the number of points of Fast Fourier Transform (FFT) used to generate the OFDM symbol. The length of the OFDM symbol may include a length of a Cyclic Prefix (CP) added to the OFDM symbol. Here, the OFDM symbol may be referred to as a symbol. In a case that a communication method other than OFDM is used in communications between the terminal apparatus 1 and the base station apparatus 3 (for example, in the use of SC-FDMA, DFT-s-OFDM, or the like), the generated SC-FDMA symbol and/or DFT-s-OFDM symbol is also referred to as an OFDM symbol. Here, for example, the length of the slot may be 0.25 ms, 0.5 ms, 1 ms, 2 ms, or 3 ms. Moreover, unless otherwise stated, OFDM includes SC-FDMA or DFT-s-OFDM.

The OFDM includes a multi-carrier communication method applying waveform shaping (Pulse Shape), PAPR reduction, out-of-band radiation reduction, or filtering, and/or phase processing (for example, phase rotation and the like). The multi-carrier communication method may be a communication method that generates/transmits a signal in which multiple subcarriers are multiplexed.

The length of the subframe may be 1 ms. The length of the subframe may be given based on the first subcarrier spacing. For example, with the first subcarrier spacing of 15 kHz, the length of the subframe may be 1 ms. The subframe may include one or more slots.

The radio frame may be given according to the number of subframes. The number of subframes for the radio frame may be, for example, 10.

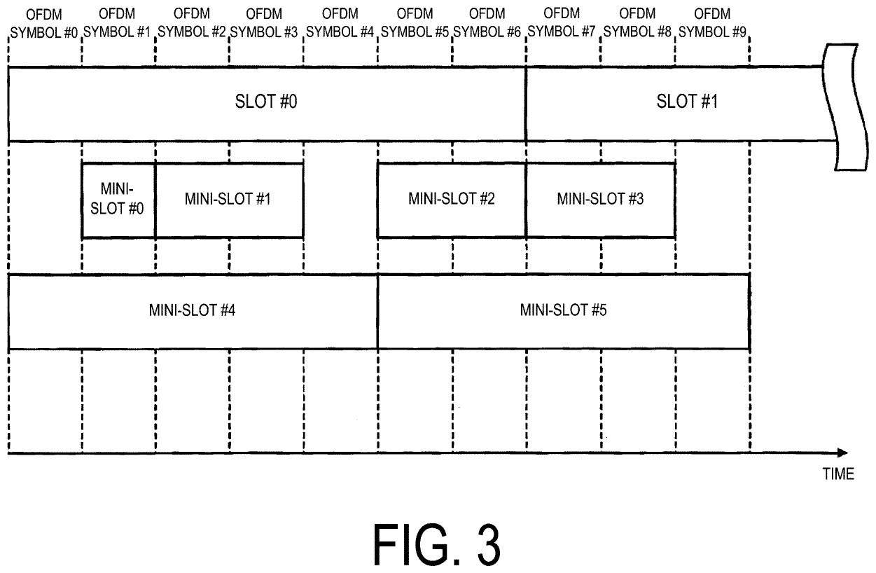

FIG. 3 is a diagram illustrating a configuration example of the slots and the mini-slots according to one aspect of the present embodiment. In FIG. 3, the number of OFDM symbols constituting the slot is seven. A mini-slot may include one or more OFDM symbols the number of which is smaller than the number of multiple OFDM symbols constituting a slot. The length of the mini-slot may be shorter than that of the slot. FIG. 3 illustrates a mini-slot #0 to a mini-slot #5 as an example of the configuration of the mini-slot. The mini-slot may include a single OFDM symbol, as indicated by the mini-slot #0. The mini-slot may include two OFDM symbols as indicated by the mini-slots #1 to #3. Moreover, a gap may be inserted between two mini-slots, as indicated by the mini-slots #1 and #2. Moreover, the mini-slot may be configured to cross a boundary between the slots #0 and #1, as indicated in the mini-slot #5. In other words, the mini-slot may be configured so as to cross the boundary between the slots. Here, the mini-slot is also referred to as a sub-slot. The mini-slot is also referred to as short Transmission Time Interval (short TTI (sTTI)). Moreover, in the following, the slot may be replaced by the mini-slot. The mini-slot may include the same number of OFDM symbols as that of the slot. The mini-slot may include OFDM symbols the number of which is larger than the number of multiple OFDM symbols constituting a slot. A length of the mini-slot in the time domain may be shorter than a length of the slot. The length of the mini-slot in the time domain may be shorter than a length of a subframe.

Physical channels and physical signals according to various aspects of the present embodiment will be described.

In FIG. 1, the following uplink physical channels are at least used for uplink radio communication from the terminal apparatus 1 to the base station apparatus 3. The uplink physical channels are used by a physical layer for transmission of information output from a higher layer.
Physical Uplink Control Channel (PUCCH)
Physical Uplink Shared Channel (PUSCH)
Physical Random Access Channel (PRACH)

The PUCCH is used to transmit Uplink Control Information (UCI). The uplink control information includes Channel State Information (CSI) of a downlink channel, a Scheduling Request (SR) used to request a PUSCH (UL-SCH: Uplink-Shared Channel) resource for a new transmission, and a Hybrid Automatic Repeat request ACKnowledgement (HARQ-ACK) for downlink data (Transport block (TB), a Medium Access Control Protocol Data Unit (MAC PDU), Downlink-Shared Channel (DL-SCH), and a Physical Downlink Shared Channel (PDSCH)). The HARQ-ACK indicates an acknowledgement (ACK) or a negative-acknowledgement (NACK). The HARQ-ACK is also referred to as HARQ feedback, HARQ information, HARQ control information, and ACK/NACK.

The Channel State Information (CSI) includes at least a Channel Quality Indicator (CQI) and a Rank Indicator (RI). The channel quality indicator may include a Precoder Matrix Indicator (PMI). The CQI is an indicator associated with channel quality (propagation strength), and the PMI is an indicator for indicating a precoder. The RI is an indicator for indicating a transmission rank (or the number of transmission layers).

The PUSCH is used to transmit uplink data (TB, MAC PDU, UL-SCH, PUSCH). The PUSCH may be used to transmit HARQ-ACK and/or channel state information together with the uplink data. Furthermore, the PUSCH may be used to transmit only the channel state information or to transmit only the HARQ-ACK and the channel state information. The PUSCH is used to transmit a random access message 3.

The PRACH is used to transmit a random access preamble (random access message 1). The PRACH is used for indicating initial connection establishment procedure, handover procedure, connection re-establishment procedure, synchronization (timing adjustment) for uplink data transmission, and a request for a PUSCH (UL-SCH) resource. The random access preamble may be used to notify the base station apparatus 3 of an index (random access preamble index) given by the higher layer of the terminal apparatus 1.

The random access preamble may be provided by cyclic-shifting of a Zadoff-Chu sequence corresponding to a physical root sequence index u. The Zadoff-Chu sequence may be generated based on the physical root sequence index u. In a single cell, multiple random access preambles may be defined. The random access preamble may be identified based on at least the index of the random access preamble. Different random access preambles corresponding to different indices of random access preambles may correspond to different combinations of the physical root sequence index u and the cyclic shift. The physical root sequence index u and the cyclic shift may be provided based on at least information included in the system information. The physical root sequence index u may be an index for identifying a sequence included in the random access preamble. The random access preamble may be identified based on at least the physical root sequence index u.

In FIG. 1, the following uplink physical signal is used for the uplink radio communication. The uplink physical signal need not be used for transmitting information output from the higher layer, but is used by the physical layer.
Uplink Reference Signal (UL RS)

According to the present embodiment, at least the following two types of uplink reference signals may be used.
Demodulation Reference Signal (DMRS)
Sounding Reference Signal (SRS)

The DMRS is associated with transmission of the PUSCH and/or the PUCCH. The DMRS is multiplexed with the PUSCH or the PUCCH. The base station apparatus 3 uses the DMRS in order to perform channel compensation of the PUSCH or the PUCCH. Transmission of both of the PUSCH and the DMRS is hereinafter referred to simply as transmission of the PUSCH. Transmission of both of the PUCCH and the DMRS is hereinafter referred to simply as transmission of the PUCCH.

The SRS need not be associated with transmission of the PUSCH or the PUCCH. The base station apparatus 3 may use the SRS to measure the channel state. The SRS may be transmitted at the end of the subframe in an uplink slot or in a prescribed number of OFDM symbols from the end.

In FIG. 1, the following downlink physical channels are used for downlink radio communication from the base station apparatus 3 to the terminal apparatus 1. The downlink physical channels are used by the physical layer for transmission of information output from the higher layer.
Physical Broadcast Channel (PBCH)
Physical Downlink Control Channel (PDCCH)
Physical Downlink Shared Channel (PDSCH)

The PBCH is used for broadcasting a Master Information Block (MIB, a Broadcast Channel (BCH)) that is commonly used by the terminal apparatuses 1. The PBCH may be transmitted based on a prescribed transmission interval. For example, the PBCH may be transmitted at an interval of 80 ms. Contents of information included in the PBCH may be updated at every 80 ms. The PBCH may include 288 subcarriers. The PBCH may include 2, 3, or 4 OFDM symbols. The MIB may include information relating to an identifier (index) for a synchronization signal. The MIB may include information for indicating at least a part of a number of the slot in which PBCH is transmitted, a number of the subframe in which PBCH is transmitted, and a number of the radio frame in which PBCH is transmitted.

The PDCCH (NR PDCCH) is used to transmit and/or receive Downlink Control Information (DCI). The downlink control information is also referred to as a DCI format. The downlink control information may include at least either a downlink grant or an uplink grant. The downlink grant is also referred to as a downlink assignment or a downlink allocation.

A single downlink grant is used for at least scheduling of a single PDSCH within a single serving cell. The downlink grant is used at least for the scheduling of the PDSCH in the same slot as the slot in which the downlink grant is transmitted. The downlink grant may be used for the scheduling of the PDSCH in a slot different from the slot in which the downlink grant is transmitted.

A single uplink grant is used at least for scheduling of a single PUSCH in a single serving cell.

In the terminal apparatus 1, one or more control resource sets (CORESETs) are configured for searching for the PDCCH. The terminal apparatus 1 attempts to receive the PDCCH in the configured control resource set. Details of the control resource set will be described later.

The PDSCH is used to transmit and/or receive downlink data (DL-SCH, PDSCH). The PDSCH is at least used to transmit a random access message 2 (random access response). The PDSCH is at least used to transmit the system information including parameters used for initial access.

In FIG. 1, the following downlink physical signals are used for the downlink radio communication. The downlink physical signal need not be used for transmitting and/or receiving the information output from the higher layer, but is used by the physical layer.
Synchronization signal (SS)
Downlink Reference Signal (DL RS)

The synchronization signal is used for the terminal apparatus 1 to establish synchronization in a frequency domain and a time domain in the downlink. The synchronization signal includes a Primary Synchronization Signal (PSS) and a Second Synchronization Signal (SSS).

The downlink reference signal is used for the terminal apparatus 1 to perform channel compensation on a downlink physical channel. The downlink reference signal is used for the terminal apparatus 1 to obtain the downlink channel state information.

According to the present embodiment, the following two types of downlink reference signals are used.
DeModulation Reference Signal (DMRS)
Shared Reference Signal (Shared RS)

The DMRS is associated with transmission of the PDCCH and/or the PDSCH. The DMRS is multiplexed with the PDCCH or the PDSCH. In order to perform channel compensation of the PDCCH or the PDSCH, the terminal apparatus 1 may use the DMRS corresponding to the PDCCH or the PDSCH. Hereinafter, the transmission of the PDCCH and the DMRS corresponding to the PDCCH together is simply referred to as transmission of the PDCCH. Hereinafter, the reception of the PDCCH and the DMRS corresponding to the PDCCH together is simply referred to as reception of the PDCCH. Hereinafter, the transmission of the PDSCH and the DMRS corresponding to the PDSCH together is simply referred to as transmission of the PDSCH. Hereinafter, the reception of the PDSCH and the DMRS corresponding to the PDSCH together is simply referred to as reception of the PDSCH.

The Shared RS may be associated with transmission of at least PDCCH. The Shared RS may be multiplexed with the PDCCH. The terminal apparatus 1 may use the Shared RS to perform channel compensation of the PDCCH. Hereinafter, the transmission of the PDCCH and the Shared RS together is also simply referred to as transmission of the PDCCH. Hereinafter, the reception of the PDCCH and the Shared RS together is also simply referred to as reception of the PDCCH.

The DMRS may be an RS which is individually configured for the terminal apparatus 1. The sequence of DMRS may be provided based on at least parameters individually configured for the terminal apparatus 1. The DMRS may be individually transmitted for the PDCCH and/or the PDSCH. On the other hand, the Shared RS may be an RS which is commonly configured for multiple terminal apparatuses 1. The sequence of Shared RS may be provided regardless of parameters individually configured for the terminal apparatus 1. For example, the Shared RS sequence may be given based on at least some of the slot number, the mini-slot number, or a cell ID (identity). The Shared RS may be RS transmitted regardless of whether the PDCCH and/or the PDSCH is transmitted.

The downlink physical channel and the downlink physical signal are also referred to as a downlink signal. The uplink physical channel and the uplink physical signal are also referred to as an uplink signal. The downlink physical channels and the uplink physical channels are collectively referred to as a physical channel. The downlink physical signals and the uplink physical signals are collectively referred to as a physical signal.

The BCH, the UL-SCH, and the DL-SCH are transport channels. The channel used in the Medium Access Control (MAC) layer is referred to as a transport channel. The unit of transport channels used in the MAC layer is also referred to as a transport block or a MAC PDU. A Hybrid Automatic Repeat reQuest (HARQ) is controlled for each transport block in the MAC layer. The transport block is a unit of data that the MAC layer delivers to the physical layer. In the physical layer, the transport block is mapped to a codeword, and modulation processing is performed for each codeword.

The base station apparatus 3 and the terminal apparatus 1 exchange (transmit and/or receive) a signal in the higher layer. For example, the base station apparatus 3 and the terminal apparatus 1 may transmit and/or receive Radio Resource Control (RRC) signaling (also referred to as a Radio Resource Control (RRC) message or Radio Resource Control (RRC) information) in a Radio Resource Control (RRC) layer. Furthermore, the base station apparatus 3 and the terminal apparatus 1 may transmit and/or receive a MAC Control Element (CE) in the MAC layer. Here, the RRC signaling and/or the MAC CE is also referred to as higher layer signaling.

The PUSCH and the PDSCH are at least used to transmit the RRC signaling and the MAC CE. Here, the RRC signaling transmitted from the base station apparatus 3 through the PDSCH may be signaling common to the multiple terminal apparatuses 1 in a cell. The signaling common to the multiple terminal apparatuses 1 in the cell is also referred to as common RRC signaling. The RRC signaling transmitted from the base station apparatus 3 through the PDSCH may be signaling dedicated to a certain terminal apparatus 1 (also referred to as dedicated signaling or UE specific signaling). The signaling dedicated to the terminal apparatus 1 is also referred to as dedicated RRC signaling. A cell-specific parameter may be transmitted by using the signaling common to the multiple terminal apparatuses 1 in the cell or the signaling dedicated to the certain terminal apparatus 1. A UE-specific parameter may be transmitted by using the signaling dedicated to the certain terminal apparatus 1. The PDSCH including the dedicated RRC signaling may be scheduled via the PDCCH in the first control resource set.

Broadcast Control CHannel (BCCH), Common Control CHannel (CCCH), and Dedicated Control CHannel (DCCH) are logical channels. For example, the BCCH is a higher-layer channel used to transmit the MIB. Moreover, the Common Control Channel (CCCH) is a higher-layer channel used to transmit information common to the multiple terminal apparatuses 1. Here, the CCCH is used for the terminal apparatus 1 which is not in an RRC-connected state, for example. Moreover, the Dedicated Control Channel (DCCH) is a higher-layer channel used to transmit individual control information (dedicated control information) to the terminal apparatus 1. Here, the DCCH is used for the terminal apparatus 1 which is in an RRC-connected state, for example.

The BCCH in the logical channel may be mapped to the BCH, the DL-SCH, or the UL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel is mapped to the PUSCH in the physical channel. The DL-SCH in the transport channel is mapped to the PDSCH in the physical channel. The BCH in the transport channel is mapped to the PBCH in the physical channel.

Hereinafter, the control resource set will be described.

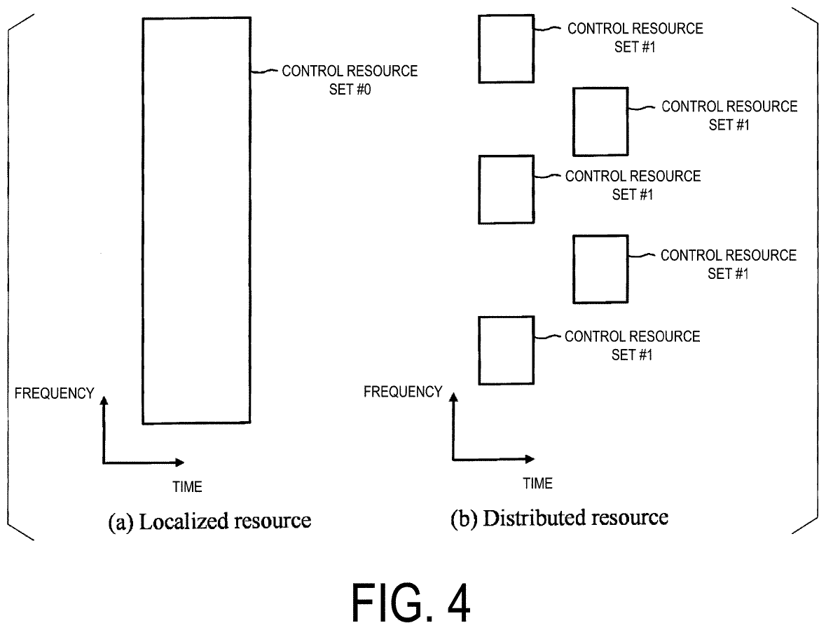

FIG. 4 is a diagram illustrating an example of mapping control resource sets according to one aspect of the present embodiment. The control resource set may indicate a time frequency domain in which one or more control channels can be mapped. The control resource set may be a region in which the terminal apparatus 1 attempts to receive and/or detect (blind detection, Blind Decoding (BD)) the PDCCH. As illustrated in FIG. 4(a), the control resource set may include a continuous resource (Localized resource) in the frequency domain. As illustrated in FIG. 4(b), the control resource set may include non-continuous resources (distributed resources) in the frequency domain.

In the frequency domain, the unit of mapping the control resource sets may be a resource block. In the time domain, the unit of mapping the control resource sets may be the OFDM symbol.

The frequency domain of the control resource set may be identical to the system bandwidth of the serving cell. The frequency domain of the control resource set may be provided based on at least the system bandwidth of the serving cell. The frequency domain of the control resource set may be provided based on at least higher-layer signaling and/or downlink control information. For example, positions of the resource blocks constituting the control resource set are notified from the base station apparatus 3 to the terminal apparatus 1 through higher layer signaling. The positions of the resource blocks constituting the control resource set is notified, for each control resource, to the terminal apparatus 1 from the base station apparatus 3 through higher layer signaling.

The time domain of the control resource set may be provided based on at least higher-layer signaling and/or downlink control information. For example, a starting position and end position of the OFDM symbols constituting the control resource set are notified from the base station apparatus 3 to the terminal apparatus 1 through higher layer signaling. For example, the number of OFDM symbols constituting the control resource set is notified from the base station apparatus 3 to the terminal apparatus 1 through higher layer signaling.

The control resource set may include at least one or both of a Common control resource set (Common CORESET) and a Dedicated control resource set (UE specific CORESET). The common control resource set may be a control resource set configured commonly to the multiple terminal apparatuses 1. The common control resource set may be provided based on at least the MIB, first system information, second system information, the common RRC signaling, the cell ID, or the like. The dedicated control resource set may be a control resource set configured to be dedicatedly used for the individual terminal apparatus 1. The dedicated control resource set may be provided based on at least dedicated RRC signaling and/or a value of C-RNTI.

The control resource set may be a set of control channels (or control channel candidates) to be monitored by the terminal apparatus 1. The control resource set may include a set of control channels (or control channel candidates) to be monitored by the terminal apparatus 1. The control resource set may be configured to include one or more Search Spaces (SS). The control resource set may be synonymous with the search space.

The search space includes one or more PDCCH candidates. The terminal apparatus 1 receives a PDCCH candidate included in the search space and attempts to receive the PDCCH. Here, the PDCCH candidate is also referred to as a blind detection candidate.

The search space may include at least one or both of Common Search Space (CSS) and UE-specific Search Space (USS). The CSS may be a search space configured commonly to the multiple terminal apparatuses 1. The USS may be a search space including a configuration dedicatedly used for the individual terminal apparatus 1. The CSS may be provided based on at least the MIB, the first system information, the second system information, the common RRC signaling, the cell ID, or the like. The USS may be provided based on at least the dedicated RRC signaling and/or the value of C-RNTI. Details of the PDCCH candidates constituting the USS of the embodiment of the present invention will be described later.

As the CSS, a type 0 PDCCH CSS for the DCI format scrambled with the SI-RNTI used to transmit the system information in the primary cell and a type 1 PDCCH CSS for the DCI format scrambled with the INT-RNTI used for initial access may be used. The terminal apparatus 1 can monitor the PDCCH candidates in those search spaces. The DCI format scrambled with a prescribed RNTI may be a DCI format to which a Cyclic Redundancy Check (CRC) scrambled with a prescribed RNTI is added.

Note that the PDCCH and/or DCI included in the CSS need not include a Carrier Indicator Field (CIF) (carrier indicator) indicating which serving cell (or which component carrier) the PDCCH and/or DCI schedules the PDSCH or PUSCH for.

Note that in a case that a carrier aggregation is configured in which multiple serving cells and/or multiple component carriers are aggregated for the terminal apparatus 1 to perform communication (transmission and/or reception), the PDCCH and/or DCI included in the USS for a prescribed serving cell (prescribed component carrier) may include the CIF indicating which serving cell and/or which component carrier the PDCCH and/or DCI schedules the PDSCH or PUSCH for.

Note that in a case that one serving cell and/or one component carrier are used for the terminal apparatus 1 to perform communication, the PDCCH and/or DCI included in the USS may not include the CIF indicating which serving cell and/or which component carrier the PDCCH and/or DCI schedules the PDSCH or PUSCH for.

The common control resource set may include at least one or both of the CSS and the USS. The dedicated control resource set may include at least one or both of the CSS and the USS. The dedicated control resource set need not include the CSS.

A physical resource of the search space includes a Control Channel Element (CCE) of the control channel. The CCE includes a predetermined number of Resource Element Groups (REGs). For example, the CCE may include six REGs. The REG may include one OFDM symbol in one Physical Resource Block (PRB). In other words, the REG may include 12 Resource Elements (REs). The PRB is also simply referred to as a Resource Block (RB).

Specifically, the terminal apparatus 1 can detect the PDCCH and/or DCI for the terminal apparatus 1 by blind detecting the PDCCH candidates included in the search space in the control resource set.

The number of blind detections for one control resource set in one serving cell and/or one component carrier may be determined based on the type of search space, the type of the aggregation level, and the number of PDCCH candidates for the PDCCH included in the control resource set. Here, the type of the terminal space may include at least one of the CSS and/or the USS and/or a UE Group SS (UGSS) and/or a Group CSS (GCSS). The type of the aggregation level indicates a maximum aggregation level supported for the CCE constituting the search space, and may be defined/configured from at least one of {1, 2, 4, 8, . . . , X} (where X is a prescribed value). The number of PDCCH candidates may indicate the number of PDCCH candidates for a certain aggregation level. In other words, the number of PDCCH candidates may be defined/configured for each of the multiple aggregation levels. The UGSS may be a search space assigned commonly to one or multiple terminal apparatuses 1. The GCSS may be a search space to which the DCI including parameters related to the CSS is mapped for one or multiple terminal apparatuses 1. Note that the aggregation level indicates an aggregation level of the prescribed number of CCEs, and is related to the total number of CCEs constituting one PDCCH and/or search space.

Note that a magnitude of the aggregation level may be associated with a coverage corresponding to the PDCCH and/or search space or a size of the DCI (DCI format size, payload size) included in the PDCCH and/or search space.

Note that in a case that a PDCCH symbol starting position (start symbol) is configured for one control resource set, and more than one PDCCH in control resource set can be detected in a prescribed duration, the type of the search space, the type of the aggregation level, and the number of PDCCH candidates for the PDCCH included in the control resource set may be configured for the time domain corresponding to each start symbol. The type of the search space, the type of the aggregation level, and the number of PDCCH candidates for the PDCCH included in the control resource set may be configured for each control resource set, may be provided/configured via the DCI and/or higher layer signaling, or may be defined/configured in advance by specifications. Note that the number of PDCCH candidates may be the number of PDCCH candidates in a prescribed duration. Note that the prescribed duration may be 1 millisecond. The prescribed duration may be 1 microsecond. The prescribed duration may also be one slot duration. The prescribed duration may be one OFDM symbol duration.

Note that in a case that the number of PDCCH symbol starting positions (start symbols) configured for one control resource set is more than one, in other words, in a case that the PDCCH is blind detected (monitored) multiple times in a prescribed duration, the type of the search space, the type of the aggregation level, and the number of PDCCH candidates for the PDCCH included in the control resource set may be configured for the time domain corresponding to each start symbol. The type of the search space, the type of the aggregation level, and the number of PDCCH candidates for the PDCCH included in the control resource set may be configured for each control resource set, may be provided/configured via the DCI and/or higher layer signaling, or may be defined/configured in advance by specifications.

Note that as a way to indicate the number of PDCCH candidates, a configuration may be used in which the number of PDCCH candidates to be subtracted from the prescribed number of PDCCH candidates is defined/configured for each aggregation level.

In a case that the control resource sets the number of which is greater than a prescribed number can be configured for one or multiple serving cells/component carriers, the terminal apparatus 1 may transmit/notify the capability information related to the blind detection to the base station apparatus 3.

In a case that the terminal apparatus 1 supports the first slot format and the second slot format, the terminal apparatus 1 may transmit/notify the capability information related to the slot format to the base station apparatus 3.

In a case that the control resource sets the number of which is greater than a prescribed number can be configured in a prescribed duration of one or multiple serving cells/component carriers, the terminal apparatus 1 may transmit/notify the capability information related to the blind detection to the base station apparatus 3.

Note that the capability information related to the blind detection may include information indicating a maximum number of blind detections in a prescribed duration. The capability information related to the blind detection may include information indicating that the PDCCH candidate can be reduced. The capability information related to the blind detection may include information indicating a maximum number of control resource sets that are detectable in blind detection in a prescribed duration. The maximum number of the control resource sets and the maximum number of serving cells and/or component carriers capable of PDCCH monitoring may be configured as individual parameters, or may be configured as a common parameter. The capability information related to the blind detection may include information indicating a maximum number of control resource sets that can be simultaneously blind detected in a prescribed duration.

In a case that the terminal apparatus 1 does not support the capability of detecting (blind detecting) the control resource sets the number of which is greater than a prescribed number in the prescribed duration, the terminal apparatus 1 may not transmit/notify the capability information related to the blind detection. In a case that the base station 3 does not receive the capability information related to the blind detection, the base station apparatus 3 may configure the control resource set to transmit the PDCCH so that the prescribed number for the blind detection is not exceeded.

The configuration for the control resource set may include a parameter indicating the PDCCH starting position (start symbol). The configuration for the control resource set may include a parameter indicating a time resource region of the control resource set (the number of OFDM symbols constituting the control resource set). The configuration for the control resource set may include a parameter indicating a frequency resource region of the control resource set (the number of resource blocks constituting the control resource set). The configuration for the control resource set may include a parameter indicating a type of mapping from the CCE to the REG. The configuration for the control resource set may include a REG bundle size. The configuration for the control resource set may include a parameter indicating a pseudo placement of PDCCH antenna ports in the control resource set (whether the PDCCH is used with the same resource as a prescribed antenna port). The configuration for the control resource set may include a parameter indicating a CCE aggregation level of the USS. The configuration for the control resource set may include a parameter indicating a period for monitoring the PDCCH and/or the control resource set. Depending on the PDCCH starting position, the maximum number of blind detections of the PDCCH may be configured individually.

The unit of the physical resource according to the present embodiment will be described below.

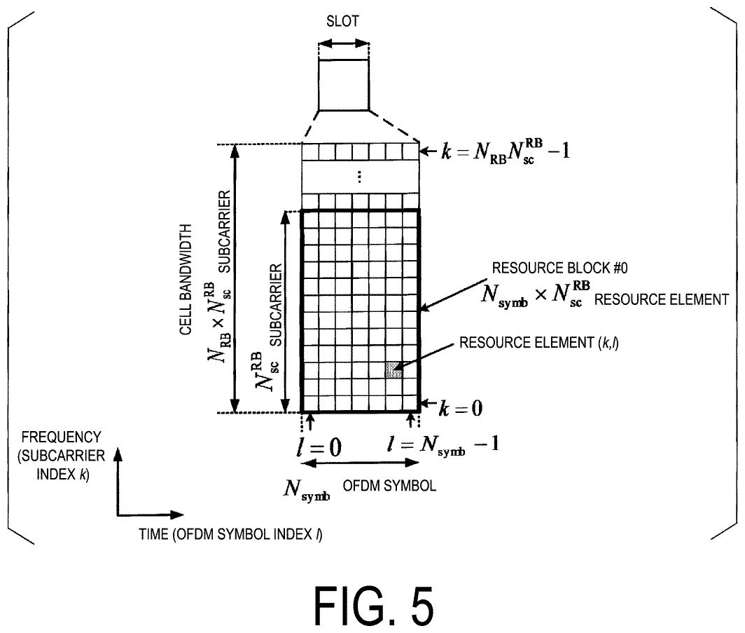

FIG. 5 is a diagram illustrating an example of resource elements included in the slot according to one aspect of the present embodiment. Here, the resource element is a resource defined by one OFDM symbol and one subcarrier. As illustrated in FIG. 5, the slot includes N_{symb} OFDM symbols. The number of subcarriers included in the slot may be given by a product of the number of resource blocks NRB included in the slot and the number of subcarriers per resource block N^{RB}_{SC}. Here, the resource block is a group of the resource elements in the time domain and the frequency domain. The resource block may be used as a unit of resource allocation in the time domain and/or the frequency domain. For example, the N^{RB}_{SC} may be 12. The N_{symb} may be the same as the number of OFDM symbols included in the subframe. The N_{symb} may be the same as the number of OFDM symbols included in the slot. N_{RB} may be given based on a bandwidth of a cell and the first subcarrier spacing. The N_{RB} may also be given based on the bandwidth of the cell and the second subcarrier spacing. The N_{RB} may be given based on higher layer signaling (for example, RRC signaling) transmitted from the base station apparatus 3, and the like. The N_{RB} may be given based on the description in the specifications, and the like. The resource element is identified by an index k for the subcarrier and an index 1 for the OFDM symbol.

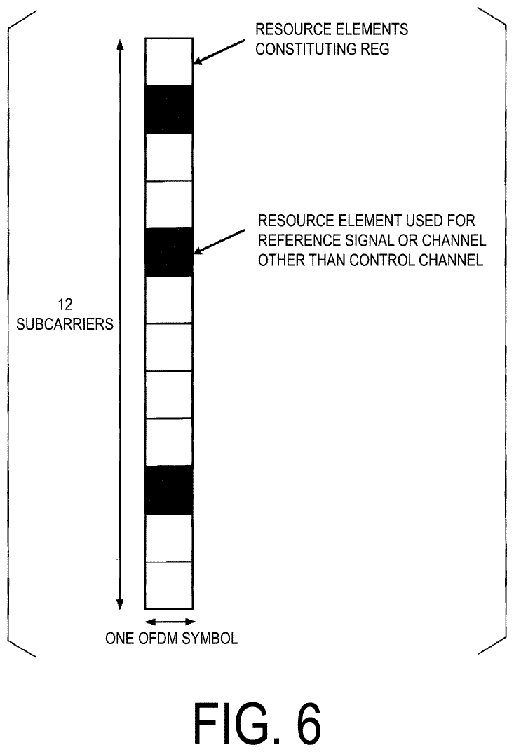

FIG. 6 is a diagram illustrating an example of a configuration of one REG according to one aspect of the present embodiment. The REG may include one OFDM symbol in one PRB. That is, the REG may include 12 continuous REs in the frequency domain. Some of the REs constituting the REG may be an RE to which the downlink control information is not mapped. The REG may be configured to include the RE to which the downlink control information is not mapped or may be configured not to include the RE to which the downlink control information is not mapped. The RE to which the downlink control information is not mapped may be an RE to which the reference signal is mapped, may be an RE to which a channel other than the control channel is mapped, or may be an RE which the terminal apparatus 1 assumes to have no control channel mapped.

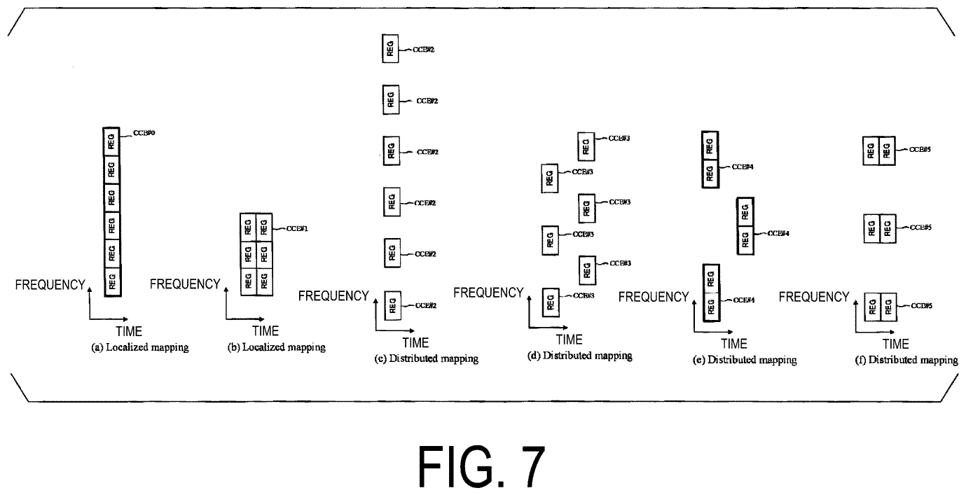

FIG. 7 is a diagram illustrating a configuration example of CCEs according to one aspect of the present embodiment. The CCE may include six REGs. As illustrated in FIG. 7(a), the CCE may include REGs continuously mapped (such mapping may be referred to as Localized mapping). Note that all REG constituting the CCE need not be continuous in the frequency domain. For example, in a case that all of the multiple resource blocks constituting the control resource set are not contiguous in the frequency domain, even though the numbers assigned to REGs is continuous, the respective resource blocks constituting each of the REGs continuously numbered are not continuous in the frequency domain. In a case that the control resource set constituted by multiple OFDM symbols and multiple REGs constituting one CCE are allocated over multiple time periods (OFDM symbols), the CCE may include a REG group that is continuously mapped as illustrated in FIG. 7(b). As illustrated in FIG. 7(c), the CCE may include REGs non-continuously mapped (such mapping may be referred to as Distributed mapping). In a case that the control resource set is constituted by multiple OFDM symbols and multiple REGs constituting one CCE are allocated over multiple time periods (OFDM symbols), the CCE may include the REGs that are different in time periods (OFDM symbols), and mixedly and non-continuously mapped as illustrated in FIG. 7(d). As illustrated in FIG. 7(e), the CCE may include the REGs that are distributed in multiple units of REG groups and mapped. As illustrated in FIG. 7(f), the CCE may include the REGs that are distributed in multiple units of REG groups and mapped.

The CCE may be include one or more REG groups. The REG group is also referred to as an REG bundle. The number of REGs constituting one REG group is referred to as Bundle size. The terminal apparatus 1 may assume that precoders applied to the REs in the REG group are the same. The terminal apparatus 1 can perform channel estimation assuming that the precoder applied to the REs in the REG group is the same. Meanwhile, the terminal apparatus 1 may assume that the precoders applied to the REs are not the same between the REG groups. In other words, the terminal apparatus 1 need not assume that the precoders applied to the REs are the same between the REG groups. The phrase “between the REG groups” may also be interpreted as “between the two different REG groups”. The terminal apparatus 1 can perform the channel estimation assuming that the precoders applied to the REs are not the same between the REG groups. The details of the REG group are described later.

The number of CCEs constituting the PDCCH candidate is also referred to as an Aggregation Level (AL). In a case that one PDCCH candidate includes aggregation of multiple CCEs, one PDCCH candidate is constituted by multiple CCEs of which CCE numbers are continuous. A collection of the PDCCH candidates with the aggregation level of ALx is also referred to as a search space with the aggregation level ALx. In other words, the search space with the aggregation level ALx may include one or more PDCCH candidates with the aggregation level of ALx. The search space may also include the PDCCH candidates with the multiple aggregation levels. For example, the CSS may include the PDCCH candidates with the multiple aggregation levels. The USS may include the PDCCH candidates with the multiple aggregation levels. A set of the aggregation levels of the PDCCH candidates included in the CSS and a set of the aggregation levels of the PDCCH candidates included in the USS may be separately defined/configured.

Hereinafter, the REG group will be described.

The REG group may be used for channel estimation in the terminal apparatus 1. For example, the terminal apparatus 1 performs the channel estimation for each REG group. This is based on a difficulty in performing the channel estimation (for example, MMSE channel estimation and the like) in the REs for the reference signals to which different precoders are applied. Here, the MMSE is an abbreviation for Minimum Mean Square Error.

The accuracy of channel estimation varies depending on at least a power allocated to the reference signal, a density of an RE in the time frequency domain, the RE being used for the reference signal, an environment of a radio channel, and the like. The accuracy of channel estimation varies depending on at least the time frequency domain used for the channel estimation. In various aspects of the present embodiment, the REG group may be used as a parameter to configure the time frequency domain used for the channel estimation.

That is, a larger REG group means that a higher gain of the channel estimation accuracy can be obtained. Meanwhile, a smaller REG group means that a larger number of REG groups are included in one PDCCH candidate. The larger number of REG groups being included in one PDCCH candidate is preferable for a transmission method (referred to as precoder rotation, precoder cycling, and the like) that obtains spatial diversity by applying different precoders to the respective REG groups.

One REG group may include the REGs continuous or close to each other in the time domain and/or the frequency domain.

The REG group in the time domain is preferable for improving the channel estimation accuracy and/or reduction in the reference signals. For example, the number of REGs constituting the REG group in the time domain may be 1, 2, 3, or another value. The number of REGs constituting the REG group in the time domain may be given based on at least the number of OFDM symbols included in the control resource set. The number of REGs constituting the REG group in the time domain may be the same as the number of OFDM symbols included in the control resource set.

The REG group in the frequency domain contributes to the improvement of the channel estimation accuracy. For example, the number of REGs constituting the REG group in the frequency domain may be 2, 3, at least a multiple of 2, or at least a multiple of 3. The number of REGs constituting the REG group in the frequency domain may be given based on at least the number of PRBs in the control resource set. The number of REGs constituting the REG group in the frequency domain may be the same as the number of PRBs included in the control resource set.

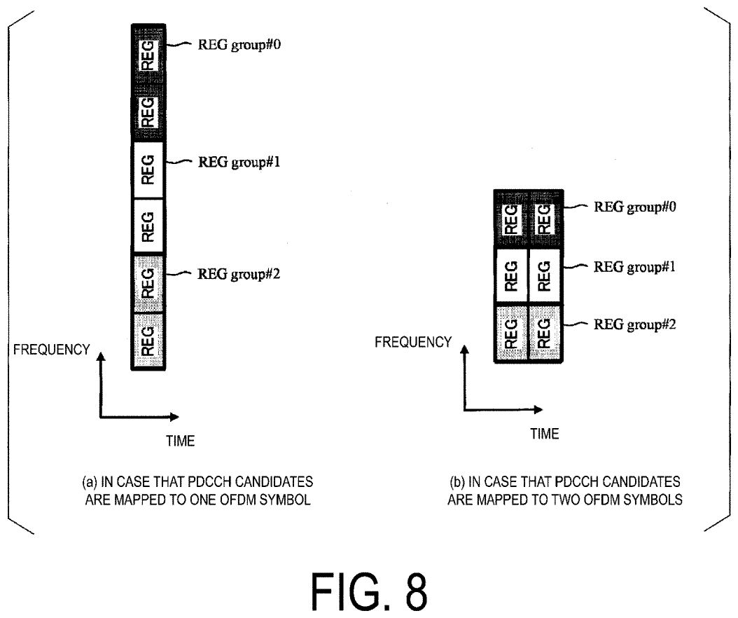

FIG. 8 is a diagram illustrating an example of the REGs constituting the PDCCH candidate and the number of REGs constituting the REG group according to one aspect of the present embodiment. In one example illustrated in FIG. 8(a), the PDCCH candidates are mapped to one OFDM symbol, and three REG groups each including two REGs are configured. Specifically, in one example illustrated in FIG. 8(a), one REG group includes two REGs. The number of REGs constituting the REG group in the frequency domain may include a divisor of the number of PRBs mapped in the frequency direction. In the example illustrated in FIG. 8(a), the number of REGs constituting the REG group in the frequency domain may be 1, 2, 3, or 6.

In one example illustrated in FIG. 8(b), the PDCCH candidates are mapped to two OFDM symbols, and three REG groups each including two REGs are configured. In one example illustrated in FIG. 8(b), the number of REGs constituting the REG group in the frequency domain may be either 1 or 3.

The number of REGs constituting the REG group in the frequency domain may be given based on at least the number of OFDM symbols to which the PDCCH candidates are mapped. The number of REGs constituting the REG group in the frequency domain may be configured individually for the number of OFDM symbols to which the PDCCH candidate is mapped. The number of OFDM symbols to which the PDCCH candidates are mapped may differ based on whether the mapping of REGs constituting the CCE is Time first mapping or Frequency first mapping. That is, the number of REGs constituting the REG group in the frequency domain may be given based on at least the mapping of the REGs constituting the CCE. The number of REGs constituting the REG group in the frequency domain may be configured individually for the mapping of the REGs constituting the CCE. The mapping of the REGs constituting the CCE may be either Time first mapping or Frequency first mapping. The mapping of the REGs constituting the CCE may be either continuous mapping or non-continuous mapping. The number of REGs constituting the REG group in the frequency domain may be given based on at least the number of OFDM symbols to which one CCE is mapped. The number of REGs constituting the REG group in the frequency domain may be configured individually for the number of OFDM symbols to which one CCE is mapped.

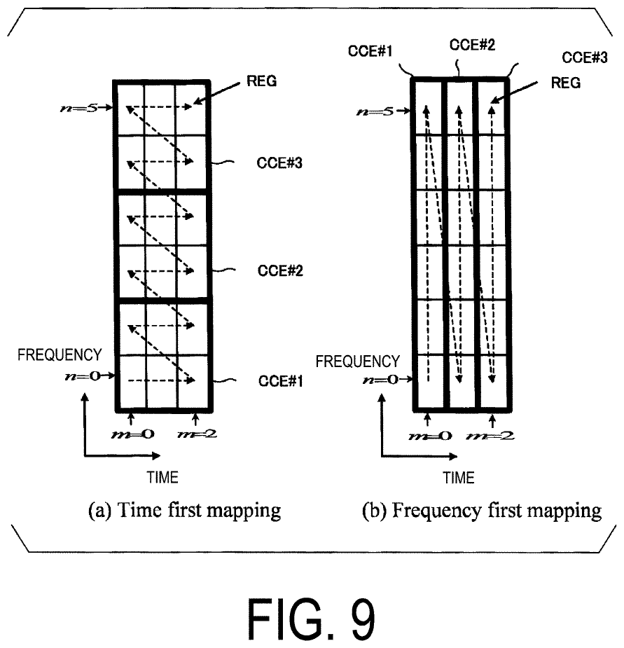

FIG. 9 is a diagram illustrating an example of mapping of REGs constituting the CCE according to one aspect of the present embodiment. Here, a case that the number of OFDM symbols constituting the control resource set is three is illustrated. In FIG. 9, the CCE includes six REGs. In FIG. 9, the REGs in the time domain are indexed from the left by indices m having values of m=0 to 2 (0, 1, 2). In FIG. 9, the REGs in the frequency domain are indexed from below by indices n having values of n=0 to 5 (0, 1, 2, 3, 4, 5). FIG. 9(a) illustrates an example in which the REGs constituting the CCE are mapped in a Time first manner. The Time first mapping is a mapping method that maps the REGs from a lower (smaller) index to a higher (larger) index of the REGs in the time domain and increment the index of the REG in the frequency domain by one at a point of time when the index of the REG in the time domain reaches the maximum. FIG. 9(b) illustrates an example in which the REGs constituting the CCE are mapped in a Frequency first manner. The Frequency first mapping is a mapping method that maps the REGs from a lower (smaller) index to a higher (larger) index of the REGs in the frequency domain and increment the index of the REG in the time domain by one at a point of time when the index of the REG in the frequency domain reaches the maximum.

The number of REGs constituting the REG group in the time domain may be given based on at least the number of OFDM symbols to which the PDCCH candidates are mapped. The number of REGs constituting the REG group in the time domain may be configured individually for the number of OFDM symbols to which the PDCCH candidates are mapped. The number of OFDM symbols to which the PDCCH candidates are mapped may differ based on whether the mapping of REGs constituting the CCE is Time first mapping or Frequency first mapping. That is, the number of REGs constituting the REG group in the time domain may be given based on at least the mapping of the REGs constituting the CCE. The number of REGs constituting the REG group in the time domain may be configured individually for the mapping of the REGs constituting the CCE. The mapping of the REGs constituting the CCE may be Time first mapping or Frequency first mapping. Alternatively, the mapping of the REGs constituting the CCE may be continuous mapping or non-continuous mapping. The number of REGs constituting the REG group in the time domain may be given based on at least the number of OFDM symbols to which one CCE is mapped. The number of REGs constituting the REG group in the time domain may be configured individually for the number of OFDM symbols to which one CCE is mapped.

The REG group in the time domain is also preferable for reduction in the reference signals. As illustrated in FIG. 8(b), in a case that the REG group is configured, the reference signal may be included in an anterior OFDM symbol and/or a posterior OFDM symbol. For example, in the time domain, the first REG (head REG) in the REG group may include an RE to which the downlink control information is not mapped, and REGs other than the first REG in the REG group need not include REs to which the downlink control information is not mapped.

A configuration example of the terminal apparatus 1 according to one aspect of the present embodiment will be described below.

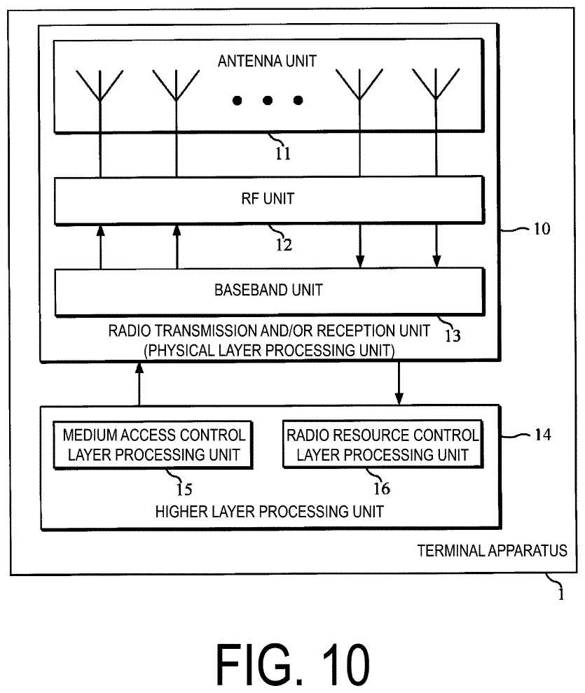

FIG. 10 is a schematic block diagram illustrating the configuration of the terminal apparatus 1 according to the present embodiment. As illustrated, the terminal apparatus 1 includes a radio transmission and/or reception unit 10 and a higher layer processing unit 14. The radio transmission and/or reception unit 10 includes an antenna unit 11, a Radio Frequency (RF) unit 12, and a baseband unit 13. The higher layer processing unit 14 includes a medium access control layer processing unit 15 and a radio resource control layer processing unit 16. The radio transmission and/or reception unit 10 is also referred to as a transmitter, a receiver or a physical layer processing unit. The physical layer processing unit includes a decoding unit. The receiver in the terminal apparatus 1 receives the PDCCH. The decoding unit in the terminal apparatus 1 decodes the received PDCCH. More specifically, the decoding unit in the terminal apparatus 1 performs blind decoding processing on the received signal of the resource to which the PDCCH candidate in the USS corresponds.

The higher layer processing unit 14 outputs uplink data (transport block) generated by a user operation or the like, to the radio transmission and/or reception unit 10. The higher layer processing unit 14 performs processing of a MAC layer, a Packet Data Convergence Protocol (PDCP) layer, a Radio Link Control (RLC) layer, and an RRC layer.

The medium access control layer processing unit 15 included in the higher layer processing unit 14 performs processing of the MAC layer.

The radio resource control layer processing unit 16 included in the higher layer processing unit 14 performs processing of the RRC layer. The radio resource control layer processing unit 16 manages various types of configuration information/parameters of the terminal apparatus 1. The radio resource control layer processing unit 16 sets various types of configuration information/parameters based on a higher layer signal received from the base station apparatus 3. Namely, the radio resource control layer processing unit 16 sets the various configuration information/parameters in accordance with the information for indicating the various configuration information/parameters received from the base station apparatus 3.

The radio transmission and/or reception unit 10 performs processing of the physical layer, such as modulation, demodulation, coding, decoding, and the like. The radio transmission and/or reception unit 10 demultiplexes, demodulates, and decodes a signal received from the base station apparatus 3, and outputs the information resulting from the decoding to the higher layer processing unit 14. The radio transmission and/or reception unit 10 generates a transmit signal by modulating and coding data, and performs transmission to the base station apparatus 3.

The RF unit 12 converts (down-converts) a signal received via the antenna unit 11 into a baseband signal by orthogonal demodulation and removes unnecessary frequency components. The RF unit 12 outputs a processed analog signal to the baseband unit.

The baseband unit 13 converts the analog signal input from the RF unit 12 into a digital signal. The baseband unit 13 removes a portion corresponding to a Cyclic Prefix (CP) from the digital signal resulting from the conversion, performs Fast Fourier Transform (FFT) of the signal from which the CP has been removed, and extracts a signal in the frequency domain.

The baseband unit 13 generates an OFDM symbol by performing Inverse Fast Fourier Transform (IFFT) of the data, adds CP to the generated OFDM symbol, generates a baseband digital signal, and converts the baseband digital signal into an analog signal. The baseband unit 13 outputs the analog signal resulting from the conversion, to the RF unit 12.

The RF unit 12 removes unnecessary frequency components from the analog signal input from the baseband unit 13 using a low-pass filter, up-converts the analog signal into a signal of a carrier frequency, and transmits the up-converted signal via the antenna unit 11. Furthermore, the RF unit 12 amplifies power. Furthermore, the RF unit 12 may have a function of controlling transmit power. The RF unit 12 is also referred to as a transmit power control unit.

A configuration example of the base station apparatus 3 according to one aspect of the present embodiment will be described below.

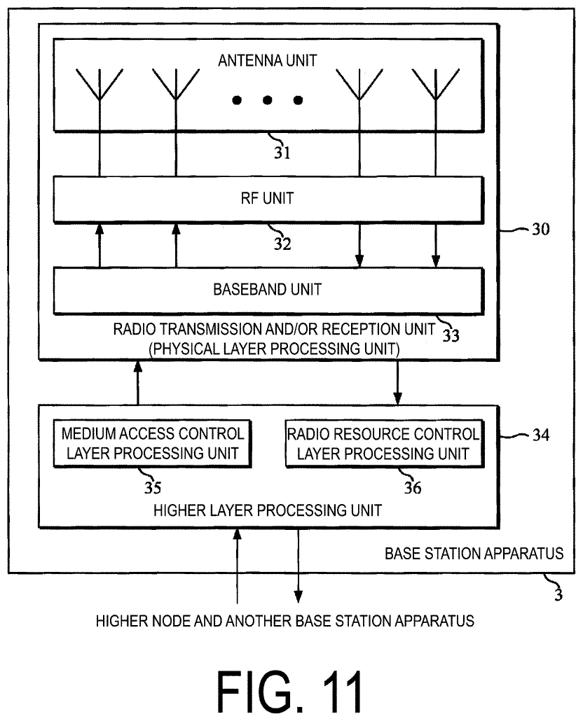

FIG. 11 is a schematic block diagram illustrating a configuration of the base station apparatus 3 according to the present embodiment. As illustrated, the base station apparatus 3 includes a radio transmission and/or reception unit 30 and a higher layer processing unit 34. The radio transmission and/or reception unit 30 includes an antenna unit 31, an RF unit 32, and a baseband unit 33. The higher layer processing unit 34 includes a medium access control layer processing unit 35 and a radio resource control layer processing unit 36. The radio transmission and/or reception unit 30 is also referred to as a transmitter, a receiver or a physical layer processing unit.

The higher layer processing unit 34 performs processing of a MAC layer, a PDCP layer, an RLC layer, and an RRC layer.

The medium access control layer processing unit 35 included in the higher layer processing unit 34 performs processing of the MAC layer.

The radio resource control layer processing unit 36 included in the higher layer processing unit 34 performs processing of the RRC layer. The radio resource control layer processing unit 36 generates, or acquires from a higher node, downlink data (transport block) allocated on PDSCH, system information, an RRC message, a MAC CE, and the like, and performs output to the radio transmission and/or reception unit 30. Furthermore, the radio resource control layer processing unit 36 manages various types of configuration information/parameters for each of the terminal apparatuses 1. The radio resource control layer processing unit 36 may set various types of configuration information/parameters for each of the terminal apparatuses 1 via higher layer signaling. That is, the radio resource control layer processing unit 36 transmits/broadcasts information for indicating various types of configuration information/parameters.

The functionality of the radio transmission and/or reception unit 30 is similar to the functionality of the radio transmission and/or reception unit 10. The radio transmission and/or reception unit 30 grasps the USS configured for the terminal apparatus 1. The radio transmission and/or reception unit 30 includes a USS grasp unit, and the USS grasp unit grasps the USS configured for the terminal apparatus 1. The radio transmission and/or reception unit 30 (transmitter) transmits a first PDCCH and a second PDCCH on a first cell, the first PDCCH including resource allocation information for a PDSCH of the first cell, the second PDCCH including resource allocation information for a PDSCH of a second cell. The USS grasp unit grasps one or more first PDCCH candidates and one or more second PDCCH candidates in the control resource set configured as a Search space for the terminal apparatus. The radio transmission and/or reception unit 30 (transmitter) transmits the first PDCCH using the first PDCCH candidates and transmits the second PDCCH using the second PDCCH candidates. The second PDCCH candidate with a first aggregation level is constituted by multiple CCEs that are shifted based on a carrier indicator (carrier indicator value) relative to multiple CCEs constituting the first PDCCH candidate with the first aggregation level, and the second PDCCH candidate with a second aggregation level is constituted by one or more CCEs among the multiple CCEs constituting the second PDCCH candidate with the first aggregation level.

Each of the units having the reference signs 10 to 16 included in the terminal apparatus 1 may be configured as a circuit. Each of the units having the reference signs 30 to 36 included in the base station apparatus 3 may be configured as a circuit.

An example of an initial connection procedure according to the present embodiment will be described below.

The base station apparatus 3 includes a communicable range (or a communication area) controlled by the base station apparatus 3. The communicable range is divided into one or multiple cells (or serving cells, sub-cells, beams, and the like), and communications with the terminal apparatus 1 can be managed for each cell. Meanwhile, the terminal apparatus 1 selects at least one cell from the multiple cells and attempts to establish a connection with the base station apparatus 3. Here, a first state in which the connection between the terminal apparatus 1 and at least one cell of the base station apparatus 3 is established is also referred to as RRC Connection. A second state in which the terminal apparatus 1 has not established the connection with any cell of the base station apparatus 3 is also referred to as RRC idle. In addition, a third state in which the connection of the terminal apparatus 1 with at least one cell of the base station apparatus 3 is established but some functions are limited between the terminal apparatus 1 and the base station apparatus 3 is also referred to as RRC suspended. The RRC suspended is also referred to as RRC inactive.

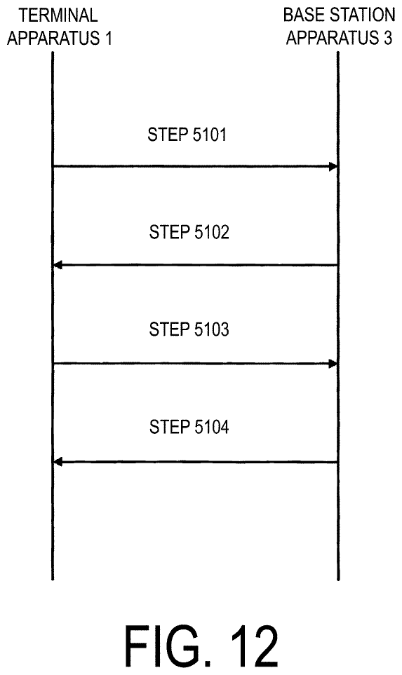

The terminal apparatus 1 in RRC idle may attempt to establish a connection with at least one cell of the base station apparatus 3. Here, the cell to which the terminal apparatus 1 attempts to connect is also referred to as a target cell. FIG. 12 is a diagram illustrating an example of a first initial connection procedure (4-step contention based RACH procedure) according to one aspect of the present embodiment. The first initial connection procedure includes at least some of Steps 5101 to 5104.

Step 5101 is a step in which the terminal apparatus 1 requests, via a physical channel, a target cell to respond for initial connection. Alternatively, step 5101 is a step in which the terminal apparatus 1 performs initial transmission to the target cell via the physical channel. Here, the physical channel may be a PRACH, for example. The physical channel may be a channel dedicatedly used to request a response for initial connection. In step 5101, the message transmitted from the terminal apparatus 1 via the physical channel is also referred to as a random access message 1. A signal of the random access message 1 may be generated based on a random access preamble index u provided by the higher layer of the terminal apparatus 1.

The terminal apparatus 1 performs downlink time-frequency synchronization prior to performing step 5101. In a first state, a synchronization signal is used for the terminal apparatus 1 to establish downlink time-frequency synchronization.

The synchronization signal may be transmitted with an ID (cell ID) of the target cell included therein. The synchronization signal may be transmitted with a sequence generated based on at least the cell ID included therein. The synchronization signal including the cell ID may mean that a sequence of synchronization signals is provided based on the cell ID. The synchronization signal may be transmitted with a beam (or precoder) applied thereto.

The beam exhibits a phenomenon that antenna gain varies according to the direction. The beam may be provided based on at least the directivity of the antenna. Moreover, the beam may be provided based on at least the phase shift of the carrier signal. Moreover, the beam may be provided by application of a precoder.

The terminal apparatus 1 receives the PBCH transmitted from the target cell. The PBCH may be transmitted that includes essential information block (Master Information Block (MIB) and Essential Information Block (EIB)) including the essential system information used for the connection of the terminal apparatus 1 with the target cell. The essential information block is system information. The essential information block may include information on the radio frame number. The essential information block may include information on a position in a super frame including multiple radio frames (e.g., information for indicating at least some of System Frame Numbers (SFNs) in the super frame). The PBCH may include an index of the synchronization signal. The PBCH may include information on the reception of a PDCCH. The essential information block may be mapped to a BCH in a transport channel. The essential information block may be mapped to a BCCH in a logical channel.

The information relating to reception of the PDCCH may include information for indicating a control resource set. The information indicating the control resource set may include information relating to the number of PRBs and/or the position to which the control resource set is mapped. The information for indicating the control resource set may include information for indicating mapping of the control resource set. The information for indicating the control resource set may include information relating to the number of OFDM symbols to which the control resource set is mapped. The information for indicating the control resource set may include information for indicating the period (periodicity) of the slot to which the control resource set is mapped. The terminal apparatus 1 may attempt to receive the PDCCH based on at least the information for indicating the control resource set included in the PBCH.

The Information relating to reception of the PDCCH may include information relating to an ID for indicating the destination of the PDCCH. The ID for indicating the destination of the PDCCH may be an ID used for scrambling the CRC-bits to be added to the PDCCH. The ID for indicating the destination of the PDCCH is also referred to as a Radio Network Temporary Identifier (RNTI). Information relating to the ID used for scrambling the CRC bits added to the PDCCH may be included. The terminal apparatus 1 may attempt to receive the PDCCH based on at least the information relating to the ID included in the PBCH.

The RNTI may include a System Information-RNTI (SI-RNTI), a Paging-RNTI (a P-RNTI), a Common RNTI (C-RNTI), a Temporary C-RNTI, and a Random Access-RNTI (RA-RNTI). The SI-RNTI is used at least for scheduling the PDSCH transmitted with system information included therein. The P-RNTI is used at least for scheduling the PDSCH transmitted with paging information and/or information such as notification of change of the system information included therein. The C-RNTI is used at least for scheduling user data to the terminal apparatus 1 in RRC connection. The Temporary C-RNTI is used at least for scheduling a random access message 4. The Temporary C-RNTI is used at least for scheduling of the PDSCH including data to be mapped to a CCCH in the logical channel. The RA-RNTI is used at least for scheduling of the random access message 2.

The information relating to reception of the PDCCH may include information relating to an aggregation level of the search space included in the control resource set. The terminal apparatus 1 may identify the aggregation level of PDCCH candidates whose reception should be attempted and determine the search space, based on at least the information relating to the aggregation level of the search space included in the control resource set included in the PBCH.

The information relating to reception of the PDCCH may include information relating to a method for mapping a REG constituting the CCE. The information relating to the method for mapping the REG constituting the CCE may include information for indicating continuous mapping and non-continuous mapping. The information relating to the method for mapping the REG constituting the CCE may include information for indicating whether the method for mapping the REG constituting the CCE is Time-first mapping or Frequency-first mapping.

The information on the reception of the PDCCH may include information on the REG group. The information on the reception of the PDCCH may include information indicating the number of REGs constituting the REG group in the frequency domain. The information on the reception of the PDCCH may include information indicating the number of REGs constituting the REG group in the time domain.

The reference signals corresponding to the control resource set may correspond to multiple PDCCH candidates included in the control resource set. The reference signals corresponding to the control resource set may be used for demodulation of the multiple PDCCHs included in the control resource set.

The base station apparatus 3 can transmit the PBCH including information on the reception of the PDCCH and indicate monitoring of a first control resource set to the terminal apparatus 1. The terminal apparatus 1 monitors the first control resource set based on at least detecting of information relating to reception of the PDCCH included in the PBCH. The first control resource set is used at least for scheduling of the first system information. The first system information may include system information important for the terminal apparatus 1 to connect to the target cell. The first system information may include information on various configurations of downlink. The first system information may include information on various configurations of PRACH. The first system information may include information on various configurations of uplink. The first system information may include information of a signal waveform (OFDM or DFT-s-OFDM) configured for random access message 3 transmission. The first system information may include at least a part of the system information other than information included in the MIB. The first system information may be mapped to the BCH in the transport channel. The first system information may be mapped to the BCCH in the logical channel. The first system information may include at least System Information Block type 1 (SIB1). The first system information may include at least System Information Block type 2 (SIB2). The first control resource set may be used for scheduling the random access message 2. The SIB1 may include information relating to a measurement required to perform RRC connection. Moreover, the SIB2 may include information relating to a channel which is common and/or shared among multiple terminal apparatuses 1 in a cell.

The terminal apparatus 1 may monitor the PDCCH based on at least the information on the reception of the PDCCH. The terminal apparatus 1 may monitor the PDCCH based on at least the information on the REG group. The terminal apparatus 1 may assume the configuration applied for monitoring the PDCCH based on at least the information on the reception of the PDCCH.

For example, the mapping method of the REGs constituting the CCE included in the control resource set may be given based on at least the number of OFDM symbols included in the control resource set. For example, in a case that the number of OFDM symbols included in the control resource set is one, the mapping method of the REGs constituting the CCE included in the control resource set may be Frequency first mapping. In addition, in a case that the number of OFDM symbols is larger than one, the mapping method of the REGs constituting the CCE included in the control resource set may be Time first mapping.

The base station apparatus 3 can transmit the MIB and/or the first system information and indicate the monitoring of the second control resource set to the terminal apparatus 1. The first system information may include the information on the reception of the PDCCH. The terminal apparatus 1 monitors the second control resource set based on at least the MIB and/or the information on the reception of the PDCCH included in the first system information. The second control resource set may be used for scheduling of the PDSCH including the paging information and/or the information for the change notification of system information. The second control resource set and the first control resource set may be the same.

The base station apparatus 3 can transmit the MIB and/or the first system information and indicate the monitoring of the third control resource set to the terminal apparatus 1. The terminal apparatus 1 monitors the third control resource set based on at least the MIB and/or the information on the reception of the PDCCH included in the first system information. The third control resource set may be used to schedule the PDSCH including the second system information. The second system information may be the system information not included in the MIB and the first system information. The second system information may be transmitted based on at least a request from the terminal apparatus 1. The request from the terminal apparatus 1 may be performed based on at least the transmission of the random access message 1, the random access message 3, and/or the PUCCH. The third control resource set may be the same as the first control resource set and/or the second control resource set.

Step 5102 is a step in which the base station apparatus 3 performs a response to the random access message 1 from the terminal apparatus 1. The response is also referred to as the random access message 2. The random access message 2 may be transmitted via the PDSCH. The PDSCH including the random access message 2 is scheduled by the PDCCH. The CRC bits included in the PDCCH may be scrambled by the RA-RNTI. The random access message 2 may be transmitted with a special uplink grant included therein. The special uplink grant is also referred to as a random access response grant. The special uplink grant may be included in the PDSCH including the random access message 2. The random access response grant may include at least a Temporary C-RNTI.

The base station apparatus 3 can transmit the MIB, the first system information, and/or the second system information, and indicate monitoring of a fourth control resource set to the terminal apparatus 1. The second system information may include the information on the reception of the PDCCH. The terminal apparatus 1 monitors the fourth control resource set based on at least the MIB, and the information on the reception of the PDCCH included in the first system information and/or the second system information. The number of CRC bits added to the PDCCH may be scrambled with Temporary C-RNTI. The fourth control resource set may be used for scheduling of the random access message 2. The fourth control resource set may be the same as the first control resource set, the second control resource set, and/or the third control resource set.

The fourth control resource set may be further given based on at least the physical root index u included in the random access message 1 transmitted from the terminal apparatus 1 and/or a resource (PRACH resource) used for transmission of the random access message 1. Here, the random access message 1 may correspond to the monitoring of the fourth control resource set. The resource may indicate a resource of a time and/or a frequency. The resource may be given by an index of a resource block and/or an index of a slot (subframe). The monitoring of the fourth control resource set may be triggered by the random access message 1.

Step 5103 is a step in which the terminal apparatus 1 transmits, to the target cell, a request for RRC connection. The request for RRC connection is also referred to as a random access message 3. The random access message 3 may be transmitted via the PUSCH scheduled by the random access response grant. The random access message 3 may include an ID used to identify the terminal apparatus 1. The ID may be an ID managed in a higher layer. The ID may be an SAE Temporary Mobile Subscriber Identity (S-TMSI). The ID may be mapped to the CCCH in the logical channel.

Step 5104 is a step in which the base station apparatus 3 transmits Contention resolution message to the terminal apparatus 1. The contention resolution message is also referred to as the random access message 4. The terminal apparatus 1, after transmitting the random access message 3, monitors the PDCCH that performs scheduling of the PDSCH including the random access message 4. The random access message 4 may include a contention avoidance ID. Here, the contention avoidance ID is used to resolve a contention in which multiple terminal apparatuses 1 transmit signals by using a same radio resource. The contention avoidance ID is also referred to as UE contention resolution identity.

In step 5104, the terminal apparatus 1 which has transmitted the random access message 3 including the ID used for identifying the terminal apparatus 1 (S-TMSI, for example) monitors the random access message 4 including the Contention resolution message. In a case that the contention avoidance ID included in the random access message 4 is identical to the ID used to identify the terminal apparatus 1, the terminal apparatus 1 may consider that the contention resolution has been successfully completed, and set the value of the Temporary C-RNTI in the C-RNTI field. The terminal apparatus 1 having the value of the Temporary C-RNTI set in the C-RNTI field is considered to have completed an RRC connection.

The control resource set to monitor the PDCCH for scheduling of the random access message 4 may be the same as the fourth control resource set. The base station apparatus 3 can transmit the information on the reception of PDCCH included in the random access message 2 and indicate the monitoring of a fifth control resource set to the terminal apparatus 1. The terminal apparatus 1 monitors the PDCCH based on at least the information relating to reception of the PDCCH included in the random access message 2. The fifth control resource set may be used for scheduling of a random access message 5.

The terminal apparatus 1 in RRC connection can receive dedicated RRC signaling mapped to the DCCH in the logical channel. The base station apparatus 3 can transmit the dedicated RRC signaling including the information on the reception of the PDCCH and indicate the monitoring of a sixth control resource set to the terminal apparatus 1. The terminal apparatus 1 may monitor the PDCCH based on at least the information on the reception of the PDCCH included in the dedicated RRC signaling. A physical resource of the sixth control resource set may be given based on at least the C-RNTI.

The base station apparatus 3 can transmit the random access message 4 including the information on the reception of the PDCCH, and indicate the monitoring of the sixth control resource set to the terminal apparatus 1. In a case that the random access message 4 includes the information on the reception of the PDCCH, the terminal apparatus 1 may monitor the sixth control resource set based on at least the information on the reception of the PDCCH. In a case that the random access message 4 does not include the information on the reception of the PDCCH, the terminal apparatus 1 may monitor the USS included in at least any of the first to the fifth control resource sets. The physical resource for the USS may be given based on at least the C-RNTI. The first to the fifth control resource sets may be common control resource sets. The sixth control resource set may be a dedicated control resource set.

The information on the reception of the PDCCH may include information common to multiple control resource sets and information configured for each of the multiple control resource sets. For example, the information on the REG group applied to the first to the fourth control resource sets may be defined. Here, the information on the reception of the PDCCH related to the first control resource set may include the information on the REG group, and the information on the reception of the PDCCH related to the second to fourth control resource sets need not include the information on the REG group. The information on the reception of the PDCCH related to the first control resource set may be applied to the second to fourth control resource sets. Here, the information on the REG group may be defined individually for each of the fifth and sixth control resource sets. Here, the information for indicating the control resource set may be defined individually for the first to sixth control resource sets.

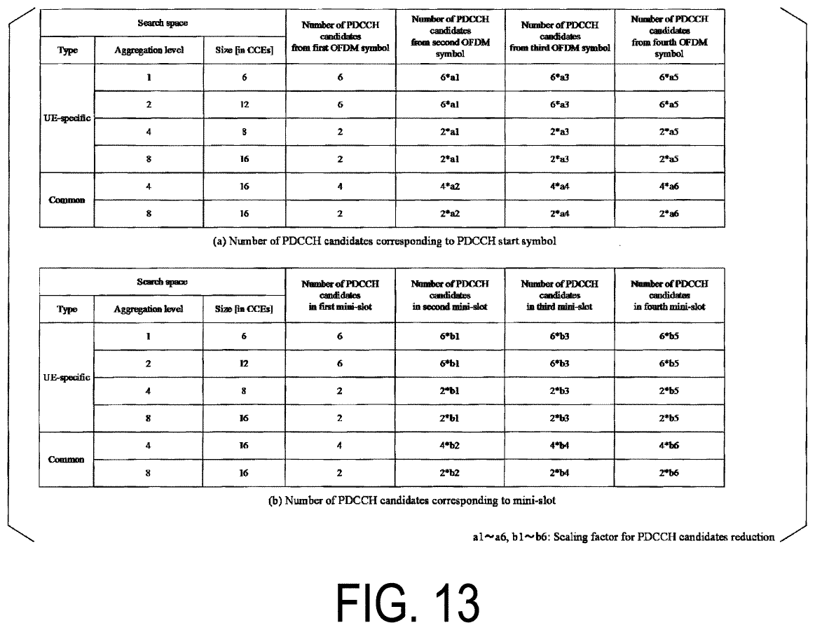

FIG. 13 is a diagram illustrating an example of a PDCCH candidate monitored by the terminal apparatus 1 according to one aspect of the present embodiment. FIG. 13(a) illustrates an example in which the number of PDCCH candidates is individually configured based on the start symbol of the PDCCH and/or control resource set. a1 to a6 are PDCCH candidate scaling factors, and therefore, the numbers of PDCCH candidates serving as references are multiplied by a1 to a6, but a1 to a6 may be added to or subtracted from the numbers of PDCCH candidates serving as references. FIG. 13(b) illustrates an example in which the number of PDCCH candidates is individually configured based on the mini-slot in which the PDCCH and/or control resource set are included. Note that an example in which four mini-slots are configured for one slot is illustrated. b1 to b6 are PDCCH candidate scaling factors, and therefore, the numbers of PDCCH candidates serving as references are multiplied by b1 to b6, but b1 to b6 may be added to or subtracted from the numbers of PDCCH candidates serving as references. Specifically, the number of blind detections based on the number of PDCCH candidates may be defined by the PDCCH start symbol and the number of the mini-slot in which the PDCCH is included. Each of a1 to a6 and b1 to b6 may be configured separately.

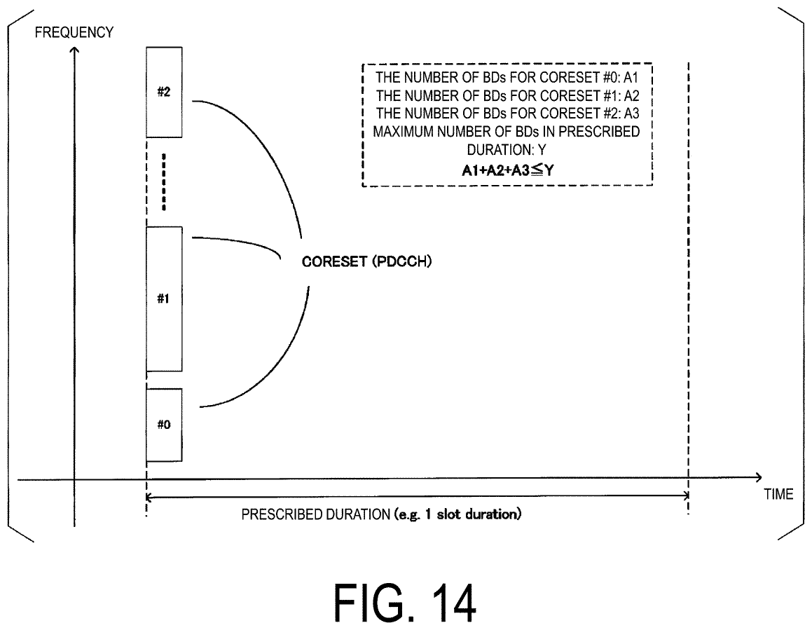

FIG. 14 is a diagram illustrating an example of allocation of a slot (first slot format)-based control resource set according to one aspect of the present embodiment. Based on the capability information from the terminal apparatus 1, the base station apparatus 3 may configure the number of PDCCH candidates and aggregation level of each control resource set, DCI format skip, or the like so that a sum of the numbers A1 to A3 of blind detections in the control resource sets #0 to #2, respectively, does not exceed the maximum number Y of blind detections in a prescribed duration.

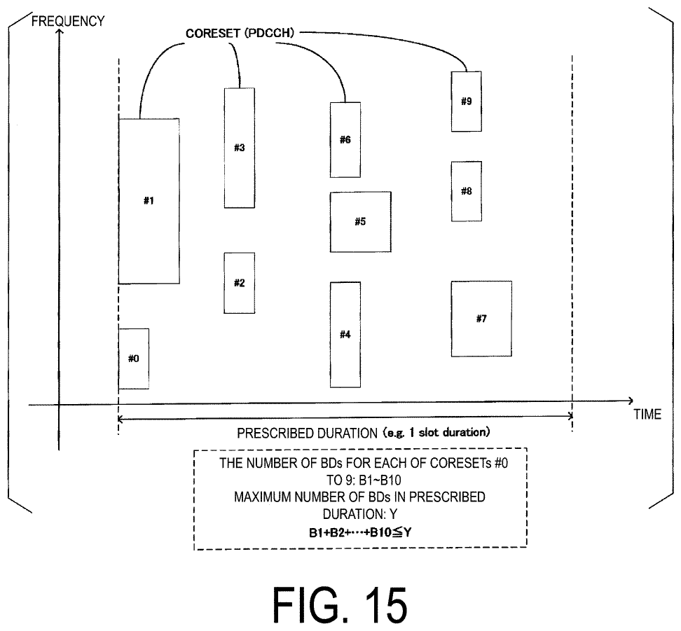

FIG. 15 is a diagram illustrating an example of allocation of a non-slot (second slot format)-based control resource set according to one aspect of the present embodiment. In this example, more than one control resource set is allocated in the time domain. Based on the capability information from the terminal apparatus 1, the base station apparatus 3 may configure the number of PDCCH candidates and aggregation level of each control resource set, DCI format skip, or the like so that a sum of the numbers B1 to B10 of blind detections in the control resource sets #0 to #9, respectively, does not exceed the maximum number Y of blind detections in a prescribed duration.

The PDCCH candidates constituting the USS of the embodiment of the present invention will be described. In the present embodiment, cross carrier scheduling is used. Cross carrier scheduling is scheduling in which resource allocation information (downlink control information) of data transmitted and received on a certain carrier (cell) is transmitted and/or received on a different carrier (cell). Specifically, both a PDCCH including resource allocation information for PDSCH of a cell 1 and a PDCCH including resource allocation information for PDSCH of a cell 2 are transmitted and/or received on the cell 1. For example, a PDSCH is transmitted and/or received on a high frequency (frequency higher than 6 GHz, millimeter wave) cell, and a PDCCH including resource allocation information for the PDSCH is transmitted and/or received in a low frequency (frequency lower than 6 GHz) cell.

In the embodiment of the present invention, a following case will be described. Note that, in the embodiment of the present invention, for the sake of convenience of description, only the following case will be described, and one aspect of the present invention is not limited to the following case. Two cells (Cell #0, Cell #1) are used, and a PDCCH for a PDSCH of Cell #0 and a PDCCH for a PDSCH of Cell #1 are transmitted and/or received on Cell #0. The PDCCH candidates of the PDCCH for the PDSCH of Cell #0 and the PDCCH candidates of the PDCCH for the PDSCH of Cell #1 are included in a USS for Cell #0. The PDCCH candidates of the PDCCH for the PDSCH of Cell #0 and the PDCCH candidates of the PDCCH for the PDSCH of Cell #1 are included (allocated, configured) in a control resource set for Cell #0. The control resource set for Cell #0 includes 32 CCEs (CCE #0 to CCE #31). The PDCCH candidates with the aggregation level 8 (AL8, one PDCCH candidate is constituted by eight CCEs), the aggregation level 4 (AL4, one PDCCH candidate is constituted by four CCEs), the aggregation level 2 (AL2, one PDCCH candidate is constituted by two CCEs, and the aggregation level 1 (AL1, one PDCCH candidate is constituted by one CCE) are included in the USS and the control resource set.

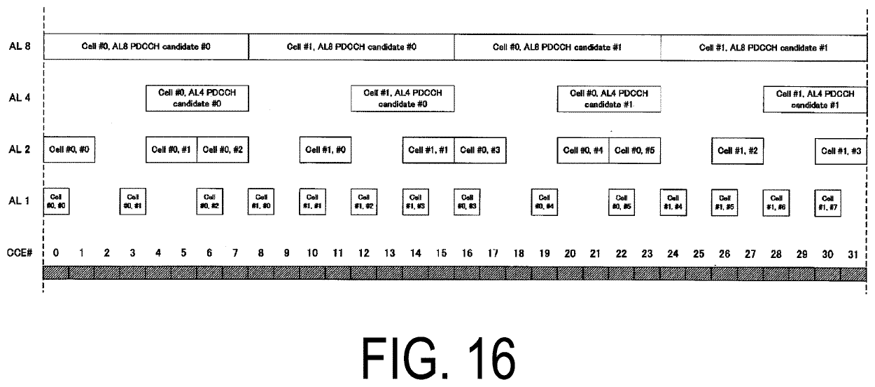

FIG. 16 is a diagram illustrating an example of the PDCCH candidates constituting the USS according to an embodiment of the present invention. In FIG. 16, the PDCCH candidates of the PDCCH for the PDSCH of Cell #0 included in the control resource set are two PDCCH candidates with the aggregation level 8 (Cell #0, AL8 PDCCH candidate #0; Cell #0, AL8 PDCCH candidate #1), two PDCCH candidates with the aggregation level 4 (Cell #0, AL4 PDCCH candidate #0; Cell #0, AL4 PDCCH candidate #1), six PDCCH candidates with the aggregation level 2 (Cell #0, AL2 PDCCH candidate #0; Cell #0, AL2 PDCCH candidate #1; Cell #0, AL2 PDCCH candidate #2; Cell #0, AL2 PDCCH candidate #3; Cell #0, AL2 PDCCH candidate #4; Cell #0, AL2 PDCCH candidate #5), and six PDCCH candidates with the aggregation level 1 (Cell #0, AL1 PDCCH candidate #0; Cell #0, AL1 PDCCH candidate #1; Cell #0, AL1 PDCCH candidate #2; Cell #0, AU PDCCH candidate #3; Cell #0, AL1 PDCCH candidate #4; Cell #0, AL1 PDCCH candidate #5). In FIG. 16, the PDCCH candidates of the PDCCH for the PDSCH of Cell #1 included in the control resource set are two PDCCH candidates with the aggregation level 8 (Cell #1, AL8 PDCCH candidate #0; Cell #1, AL8 PDCCH candidate #1), two PDCCH candidates with the aggregation level 4 (Cell #1, AL4 PDCCH candidate #0; Cell #1, AL4 PDCCH candidate #1), four PDCCH candidates with the aggregation level 2 (Cell #1, AL2 PDCCH candidate #0; Cell #1, AL2 PDCCH candidate #1; Cell #1, AL2 PDCCH candidate #2; Cell #1, AL2 PDCCH candidate #3), and eight PDCCH candidates with the aggregation level 1 (Cell #1, AL1 PDCCH candidate #0; Cell #1, AL1 PDCCH candidate #1; Cell #1, AL1 PDCCH candidate #2; Cell #1, AL1 PDCCH candidate #3; Cell #1, AL1 PDCCH candidate #4; Cell #1, AL1 PDCCH candidate #5; Cell #1, AU PDCCH candidate #6; Cell #1, AL1 PDCCH candidate #7).

In the present embodiment, the PDCCH candidates for Cell #1 (second PDCCH candidates) may be included based on at least the carrier indicator values associated with Cell #0 and Cell #1, and the maximum aggregation level (maximum value of the aggregation level) of the PDCCH candidates for Cell #0 (first PDCCH candidates). For example, the PDCCH candidates for Cell #1 with the aggregation level 8 (second PDCCH candidates) are constituted by multiple CCEs that are shifted (offset) relative to multiple CCEs constituting the PDCCH candidates for Cell #0 with the aggregation level 8 (first PDCCH candidates). To be more specific, the PDCCH candidates for Cell #1 with the aggregation level 8 (second PDCCH candidate) are constituted by multiple CCEs that are shifted, based on the carrier indicator, relative to multiple CCEs constituting the PDCCH candidates for Cell #0 with the aggregation level 8 (first PDCCH candidates). To be more specific, the PDCCH candidates for Cell #1 with the aggregation level 8 (second PDCCH candidates) are constituted by multiple CCEs that are continuous to multiple CCEs constituting the PDCCH candidates for Cell #0 with the aggregation level 8 (first PDCCH candidates). Note that the multiple continuous CCEs constituting the first PDCCH candidates and the multiple continuous CCEs constituting the second PDCCH candidates may not overlap. Here, “based on carrier indicator” means being based on a carrier indicator value that is associated in advance with Cell. For example, the carrier indicator value “0” is associated with Cell #0, and the carrier indicator value “1” is associated with Cell #1. Since the terminal apparatus 1 has grasped in advance the carrier indicator value associated with each Cell, the terminal apparatus 1 checks the carrier indicator value included in the received PDCCH to detect which Cell the received PDCCH is for. For the configuration of the PDCCH candidates for Cell #1 with the aggregation level 8, a carrier indicator value “1” is used that is associated in advance with Cell #1.

The PDCCH candidates for Cell #1 with the aggregation level 4, the aggregation level 2, and the aggregation level 1 (second PDCCH candidates) are constituted by one or more CCEs among multiple CCEs constituting the PDCCH candidates for Cell #1 with the aggregation level 8 (second PDCCH candidates).

The CCE #0 to the CCE #7 constitute Cell #0, AL8 PDCCH candidate #0. The CCE #8 to the CCE #15 that are shifted by the CCEs (eight CCEs) constituting one AL8 PDCCH candidate constitute Cell #1, AL8 PDCCH candidate #0. The carrier indicator value for Cell #1 is “1”, and the PDCCH candidates for Cell #1 are constituted at a position shifted by “one” PDCCH candidate relative to the PDCCH candidates for Cell #0. Here, the carrier indicator value of “1” in decimal representation means that the carrier indicator is “001” in 3-bit binary representation. The carrier indicator value for Cell #0 is “0” in decimal representation and “000” in 3-bit binary representation. The carrier indicator value used to indicate Cell #1 is “001” in binary representation and “1” in decimal representation. The carrier indicator value for Cell #1 is “1”, and the PDCCH candidates for Cell #1 are constituted at a position of CCE shifted by eight CCEs constituting “one” PDCCH candidate relative to the PDCCH candidates for Cell #0. Note that what is used in constituting the PDCCH candidates in the control resource set is the carrier indicator value that is associated in advance with Cell and is not a carrier indicator value that is actually received and detected. The CCE #8 to the CCE #15 continuous from the CCE #0 to the CCE #7 constitute Cell #1, AL8 PDCCH candidate #0. The CCE #16 to the CCE #23 constitute Cell #0, AL8 PDCCH candidate #1. The CCE #24 to the CCE #31 that are shifted by the CCEs (eight CCEs) constituting one AL8 PDCCH candidate constitute Cell #1, AL8 PDCCH candidate #1. The CCE #24 to the CCE #31 continuous from the CCE #16 to the CCE #23 constitute Cell #1, AL8 PDCCH candidate #1.

Cell #1, AL4 PDCCH candidate #0 is constituted by the CCE #12 to the CCE #15 among the CCE #8 to the CCE #15 constituting Cell #1, AL8 PDCCH candidate #0. Cell #1, AL4 PDCCH candidate #1 is constituted by the CCE #28 to the CCE #31 among the CCE #24 to the CCE #31 constituting Cell #1, AL8 PDCCH candidate #1. Cell #1, AL2 PDCCH candidate #0 is constituted by the CCE #10 to the CCE #11 among the CCE #8 to the CCE #15 constituting Cell #1, AL8 PDCCH candidate #0. Cell #1, AL2 PDCCH candidate #1 is constituted by the CCE #14 to the CCE #15 among the CCE #8 to the CCE #15 constituting Cell #1, AL8 PDCCH candidate #0. Cell #1, AL2 PDCCH candidate #2 is constituted by the CCE #26 to the CCE #27 among the CCE #24 to the CCE #31 constituting Cell #1, AL8 PDCCH candidate #1. Cell #1, AL2 PDCCH candidate #3 is constituted by the CCE #30 to the CCE #31 among the CCE #24 to the CCE #31 constituting Cell #1, AL8 PDCCH candidate #1. Cell #1, AL1 PDCCH candidate #0 is constituted by the CCE #8 among the CCE #8 to the CCE #15 constituting Cell #1, AL8 PDCCH candidate #0. Cell #1, AL1 PDCCH candidate #1 is constituted by the CCE #10 among the CCE #8 to the CCE #15 constituting Cell #1, AL8 PDCCH candidate #0. Cell #1, AL1 PDCCH candidate #2 is constituted by the CCE #12 among the CCE #8 to the CCE #15 constituting Cell #1, AL8 PDCCH candidate #0. Cell #1, AL1 PDCCH candidate #3 is constituted by the CCE #14 among the CCE #8 to the CCE #15 constituting Cell #1, AL8 PDCCH candidate #0. Cell #1, AL1 PDCCH candidate #4 is constituted by the CCE #24 among the CCE #24 to the CCE #31 constituting Cell #1, AL8 PDCCH candidate #1. Cell #1, AL1 PDCCH candidate #5 is constituted by the CCE #26 among the CCE #24 to the CCE #31 constituting Cell #1, AL8 PDCCH candidate #1. Cell #1, AL1 PDCCH candidate #6 is constituted by the CCE #28 among the CCE #24 to the CCE #31 constituting Cell #1, AL8 PDCCH candidate #1. Cell #1, AL1 PDCCH candidate #7 is constituted by the CCE #30 among the CCE #24 to the CCE #31 constituting Cell #1, AL8 PDCCH candidate #1.

By constituting (configuring and allocating) the PDCCH candidates constituting the USS as described above, a probability that the PDCCH candidates for different cells overlap can be reduced to ensure scheduling flexibility, and a result of channel estimation performed on each of signals of the CCEs constituting the PDCCH candidate with a high aggregation level can be reused in the reception processing of each of signals of the CCEs constituting the PDCCH candidate with a low aggregation level to reduce the processing load of the terminal apparatus 1. By taking the configuration of the PDCCH candidates in the control resource set in the cross carrier scheduling as in the embodiment of the present invention, both the ensuring the PDCCH scheduling flexibility and the reducing the processing load can be achieved.

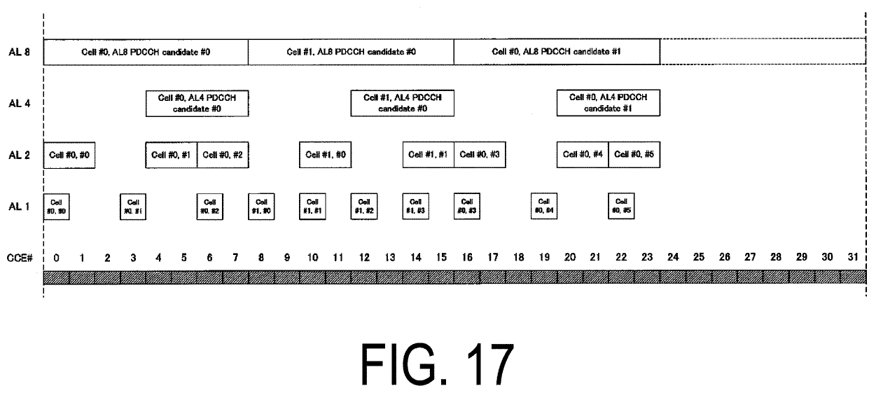

FIG. 17 is a diagram illustrating an example of the PDCCH candidates constituting the USS according to an embodiment of the present invention. In FIG. 17, the PDCCH candidates of the PDCCH for the PDSCH of Cell #0 included in the control resource set are two PDCCH candidates with the aggregation level 8 (Cell #0, AL8 PDCCH candidate #0; Cell #0, AL8 PDCCH candidate #1), two PDCCH candidates with the aggregation level 4 (Cell #0, AL4 PDCCH candidate #0; Cell #0, AL4 PDCCH candidate #1), six PDCCH candidates with the aggregation level 2 (Cell #0, AL2 PDCCH candidate #0; Cell #0, AL2 PDCCH candidate #1; Cell #0, AL2 PDCCH candidate #2; Cell #0, AL2 PDCCH candidate #3; Cell #0, AL2 PDCCH candidate #4; Cell #0, AL2 PDCCH candidate #5), and six PDCCH candidates with the aggregation level 1 (Cell #0, AL1 PDCCH candidate #0; Cell #0, AL1 PDCCH candidate #1; Cell #0, AL1 PDCCH candidate #2; Cell #0, AU PDCCH candidate #3; Cell #0, AL1 PDCCH candidate #4; Cell #0, AL1 PDCCH candidate #5). In FIG. 17, the PDCCH candidates of the PDCCH for the PDSCH of Cell #1 included in the control resource set are one PDCCH candidate with the aggregation level 8 (Cell #1, AL8 PDCCH candidate #0), one PDCCH candidate with the aggregation level 4 (Cell #1, AL4 PDCCH candidate #0), two PDCCH candidates with the aggregation level 2 (Cell #1, AL2 PDCCH candidate #0; Cell #1, AL2 PDCCH candidate #1), and four PDCCH candidates with the aggregation level 1 (Cell #1, AL1 PDCCH candidate #0; Cell #1, AL1 PDCCH candidate #1; Cell #1, AL1 PDCCH candidate #2; Cell #1, AL1 PDCCH candidate #3).

The CCE #0 to the CCE #7 constitute Cell #0, AL8 PDCCH candidate #0. The CCE #8 to the CCE #15 that are shifted by the CCEs (eight CCEs) constituting one AL8 PDCCH candidate constitute Cell #1, AL8 PDCCH candidate #0. The carrier indicator value for Cell #1 is “1”, and the PDCCH candidates for Cell #1 are constituted at a position shifted by “one” PDCCH candidate relative to the PDCCH candidates for Cell #0. The carrier indicator value for Cell #1 is “1”, and the PDCCH candidates for Cell #1 are constituted at a position of CCE shifted by eight CCEs constituting “one” PDCCH candidate relative to the PDCCH candidates for Cell #0. The CCE #8 to the CCE #15 continuous from the CCE #0 to the CCE #7 constitute Cell #1, AL8 PDCCH candidate #0.

Cell #1, AL4 PDCCH candidate #0 is constituted by the CCE #12 to the CCE #15 among the CCE #8 to the CCE #15 constituting Cell #1, AL8 PDCCH candidate #0. Cell #1, AL2 PDCCH candidate #0 is constituted by the CCE #10 to the CCE #11 among the CCE #8 to the CCE #15 constituting Cell #1, AL8 PDCCH candidate #0. Cell #1, AL2 PDCCH candidate #1 is constituted by the CCE #14 to the CCE #15 among the CCE #8 to the CCE #15 constituting Cell #1, AL8 PDCCH candidate #0. Cell #1, AL1 PDCCH candidate #0 is constituted by the CCE #8 among the CCE #8 to the CCE #15 constituting Cell #1, AL8 PDCCH candidate #0. Cell #1, AL1 PDCCH candidate #1 is constituted by the CCE #10 among the CCE #8 to the CCE #15 constituting Cell #1, AL8 PDCCH candidate #0. Cell #1, AL1 PDCCH candidate #2 is constituted by the CCE #12 among the CCE #8 to the CCE #15 constituting Cell #1, AL8 PDCCH candidate #0. Cell #1, AU PDCCH candidate #3 is constituted by the CCE #14 among the CCE #8 to the CCE #15 constituting Cell #1, AL8 PDCCH candidate #0.

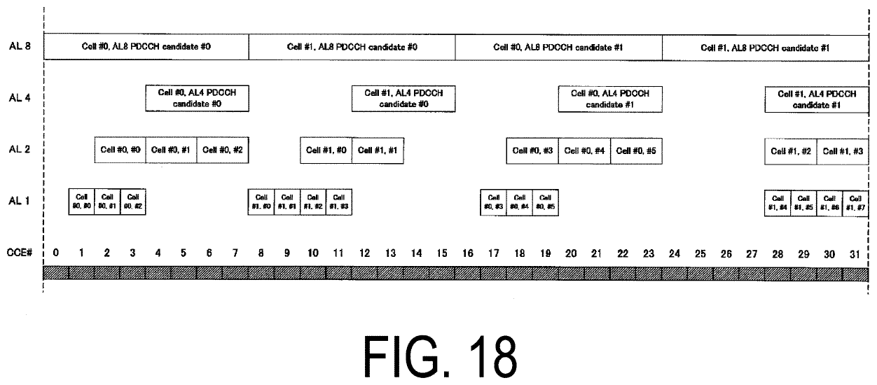

FIG. 18 is a diagram illustrating an example of the PDCCH candidates constituting the USS according to an embodiment of the present invention. In FIG. 18, the PDCCH candidates of the PDCCH for the PDSCH of Cell #0 included in the control resource set are two PDCCH candidates with the aggregation level 8 (Cell #0, AL8 PDCCH candidate #0; Cell #0, AL8 PDCCH candidate #1), two PDCCH candidates with the aggregation level 4 (Cell #0, AL4 PDCCH candidate #0; Cell #0, AL4 PDCCH candidate #1), six PDCCH candidates with the aggregation level 2 (Cell #0, AL2 PDCCH candidate #0; Cell #0, AL2 PDCCH candidate #1; Cell #0, AL2 PDCCH candidate #2; Cell #0, AL2 PDCCH candidate #3; Cell #0, AL2 PDCCH candidate #4; Cell #0, AL2 PDCCH candidate #5), and six PDCCH candidates with the aggregation level 1 (Cell #0, AL1 PDCCH candidate #0; Cell #0, AL1 PDCCH candidate #1; Cell #0, AL1 PDCCH candidate #2; Cell #0, AU PDCCH candidate #3; Cell #0, AL1 PDCCH candidate #4; Cell #0, AL1 PDCCH candidate #5). In FIG. 18, the PDCCH candidates of the PDCCH for the PDSCH of Cell #1 included in the control resource set are two PDCCH candidates with the aggregation level 8 (Cell #1, AL8 PDCCH candidate #0; Cell #1, AL8 PDCCH candidate #1), two PDCCH candidates with the aggregation level 4 (Cell #1, AL4 PDCCH candidate #0; Cell #1, AL4 PDCCH candidate #1), four PDCCH candidates with the aggregation level 2 (Cell #1, AL2 PDCCH candidate #0; Cell #1, AL2 PDCCH candidate #1; Cell #1, AL2 PDCCH candidate #2; Cell #1, AL2 PDCCH candidate #3), and eight PDCCH candidates with the aggregation level 1 (Cell #1, AL1 PDCCH candidate #0; Cell #1, AL1 PDCCH candidate #1; Cell #1, AL1 PDCCH candidate #2; Cell #1, AL1 PDCCH candidate #3; Cell #1, AL1 PDCCH candidate #4; Cell #1, AL1 PDCCH candidate #5; Cell #1, AU PDCCH candidate #6; Cell #1, AL1 PDCCH candidate #7).

The CCE #0 to the CCE #7 constitute Cell #0, AL8 PDCCH candidate #0. The CCE #8 to the CCE #15 that are shifted by the CCEs (eight CCEs) constituting one AL8 PDCCH candidate constitute Cell #1, AL8 PDCCH candidate #0. The carrier indicator value for Cell #1 is “1”, and the PDCCH candidates for Cell #1 are constituted at a position shifted by “one” PDCCH candidate relative to the PDCCH candidates for Cell #0. The carrier indicator value for Cell #1 is “1”, and the PDCCH candidates for Cell #1 are constituted at a position of CCE shifted by eight CCEs constituting “one” PDCCH candidate relative to the PDCCH candidates for Cell #0. The CCE #8 to the CCE #15 continuous from the CCE #0 to the CCE #7 constitute Cell #1, AL8 PDCCH candidate #0. The CCE #16 to the CCE #23 constitute Cell #0, AL8 PDCCH candidate #1. The CCE #24 to the CCE #31 that are shifted by the CCEs (eight CCEs) constituting one AL8 PDCCH candidate constitute Cell #1, AL8 PDCCH candidate #1. The CCE #24 to the CCE #31 continuous from the CCE #16 to the CCE #23 constitute Cell #1, AL8 PDCCH candidate #1.

Cell #1, AL4 PDCCH candidate #0 is constituted by the CCE #12 to the CCE #15 among the CCE #8 to the CCE #15 constituting Cell #1, AL8 PDCCH candidate #0. Cell #1, AL4 PDCCH candidate #1 is constituted by the CCE #28 to the CCE #31 among the CCE #24 to the CCE #31 constituting Cell #1, AL8 PDCCH candidate #1. Cell #1, AL2 PDCCH candidate #0 is constituted by the CCE #10 to the CCE #11 among the CCE #8 to the CCE #15 constituting Cell #1, AL8 PDCCH candidate #0. Cell #1, AL2 PDCCH candidate #1 is constituted by the CCE #12 to the CCE #13 among the CCE #8 to the CCE #15 constituting Cell #1, AL8 PDCCH candidate #0. Cell #1, AL2 PDCCH candidate #2 is constituted by the CCE #28 to the CCE #29 among the CCE #24 to the CCE #31 constituting Cell #1, AL8 PDCCH candidate #1. Cell #1, AL2 PDCCH candidate #3 is constituted by the CCE #30 to the CCE #31 among the CCE #24 to the CCE #31 constituting Cell #1, AL8 PDCCH candidate #1. Cell #1, AL1 PDCCH candidate #0 is constituted by the CCE #8 among the CCE #8 to the CCE #15 constituting Cell #1, AL8 PDCCH candidate #0. Cell #1, AL1 PDCCH candidate #1 is constituted by the CCE #9 among the CCE #8 to the CCE #15 constituting Cell #1, AL8 PDCCH candidate #0. Cell #1, AL1 PDCCH candidate #2 is constituted by the CCE #10 among the CCE #8 to the CCE #15 constituting Cell #1, AL8 PDCCH candidate #0. Cell #1, AL1 PDCCH candidate #3 is constituted by the CCE #11 among the CCE #8 to the CCE #15 constituting Cell #1, AL8 PDCCH candidate #0. Cell #1, AL1 PDCCH candidate #4 is constituted by the CCE #28 among the CCE #24 to the CCE #31 constituting Cell #1, AL8 PDCCH candidate #1. Cell #1, AL1 PDCCH candidate #5 is constituted by the CCE #29 among the CCE #24 to the CCE #31 constituting Cell #1, AL8 PDCCH candidate #1. Cell #1, AL1 PDCCH candidate #6 is constituted by the CCE #30 among the CCE #24 to the CCE #31 constituting Cell #1, AL8 PDCCH candidate #1. Cell #1, AL1 PDCCH candidate #7 is constituted by the CCE #31 among the CCE #24 to the CCE #31 constituting Cell #1, AL8 PDCCH candidate #1.

As for the PDCCH candidates for Cell #0 with the aggregation level 8, the CCEs constituting each PDCCH candidate are determined by a hash function using at least a UE ID (RNTI, C-RNTI) of the terminal apparatus 1 and the total number of CCEs in the control resource set. The hash function using the UE ID of the terminal apparatus 1 allows the CCEs constituting the PDCCH candidates to be randomized between the terminal apparatuses 1. The candidates for CCE constituting the PDCCH candidate with the aggregation level 8 are all CCEs in the control resource set. The PDCCH candidates for Cell #0 with the aggregation level 4, the aggregation level 2, and the aggregation level 1 are constituted by the CCEs among the CCEs constituting the PDCCH candidates with the aggregation level 8. Among the CCEs constituting the PDCCH candidates with the aggregation level 8, the CCEs constituting the PDCCH candidate are determined for each of the PDCCH candidate with the aggregation level 4, the PDCCH candidate with the aggregation level 2, and the PDCCH candidate with the aggregation level 1 by the hash function using the UE ID of the terminal apparatus 1. By limiting the CCE serving as a candidate to the CCE constituting the PDCCH candidate with the aggregation level 8, a value of the channel estimation performed on the signal of the CCE constituting the PDCCH candidate with the aggregation level 8 can be reused in the reception processing of the signal of the CCE constituting the PDCCH candidate for each of the PDCCH candidate with the aggregation level 4, the PDCCH candidate with the aggregation level 2, and the PDCCH candidate with the aggregation level 1 to reduce the processing load for the channel estimation. The PDCCH candidates for Cell #1 with the aggregation level 8 are constituted by the CCEs that are shifted, based on the carrier indicator, relative to the PDCCH candidates for Cell #0 with the aggregation level 8. The PDCCH candidates for Cell #1 with the aggregation level 4, the aggregation level 2, and the aggregation level 1 are constituted by the CCEs among the CCEs constituting the PDCCH candidates with the aggregation level 8. Among the CCEs constituting the PDCCH candidates with the aggregation level 8, the CCEs constituting the PDCCH candidate are determined for each of the PDCCH candidate with the aggregation level 4, the PDCCH candidate with the aggregation level 2, and the PDCCH candidate with the aggregation level 1 by the hash function using the UE ID of the terminal apparatus 1.

As described above, the PDCCH candidate for Cell #0 with the aggregation level 8 and the PDCCH candidate for Cell #1 with the aggregation level 8 can be constituted by the CCEs that are as exclusive as possible to reduce the problem that the CCEs constituting both PDCCH candidates overlap, resulting in that in a case that a PDCCH is actually transmitted and/or received in one PDCCH candidate (e.g. the PDCCH candidate for Cell #0 with the aggregation level 8), a PDCCH cannot be transmitted and/or received in the other PDCCH candidate (e.g., the PDCCH candidate for Cell #1 with the aggregation level 8). As described above, also for Cell #1 to which the cross carrier scheduling is applied, by limiting the CCE serving as a candidate to the CCE constituting the PDCCH candidate with the aggregation level 8, a value of the channel estimation performed on the signal of the CCE constituting the PDCCH candidate with the aggregation level 8 can be reused in the reception processing of the signal of the CCE constituting the PDCCH candidate for each of the PDCCH candidate with the aggregation level 4, the PDCCH candidate with the aggregation level 2, and the PDCCH candidate with the aggregation level 1 to reduce the processing load for the channel estimation also in the reception processing of the PDCCH for Cell #1.

In the embodiments of the present invention, the aggregation level 8 can be referred to as the highest (largest) aggregation level for the multiple PDCCH candidates constituting the USS. In the embodiments of the present invention, the aggregation level 8 can be referred to as the highest (largest) aggregation level for the multiple PDCCH candidates included in the control resource set. In the embodiments of the present invention, the case that the aggregation level 8 is the highest aggregation level is described, but an aspect of the present invention can be applied even in a case that, for example, the aggregation level 4 is the highest aggregation level in the control resource set (USS). Although not described in the embodiments of the present invention, an aspect of the present invention can be applied in a case that the aggregation level 16 or the aggregation level 32 is the highest aggregation level in the control resource set (USS).

Various aspects of devices according to one aspect of the present embodiment will be described below.

(1) To accomplish the object described above, aspects of the present invention are contrived to provide the following measures. Specifically, a first aspect of the present invention is a terminal apparatus that receives a first PDCCH and a second PDCCH in a first cell, the first PDCCH including resource allocation information for a PDSCH of the first cell, the second PDCCH including resource allocation information for a PDSCH of a second cell, the terminal apparatus including: a receiver configured to monitor one or more first PDCCH candidates and one or more second PDCCH candidates in a control resource set; and a decoding unit configured to decode a first PDCCH candidate of the one or more first PDCCH candidates and a second PDCCH candidate of the one or more second PDCCH candidates, wherein the second PDCCH candidate with a first aggregation level includes multiple CCEs that are shifted, based on a carrier indicator, relative to multiple CCEs constituting the first PDCCH candidate with the first aggregation level, and the second PDCCH candidate with a second aggregation level includes one or more CCEs among the multiple CCEs constituting the second PDCCH candidate with the first aggregation level.

(2) A second aspect of the present invention is a communication method used for a terminal apparatus that receives a first PDCCH and a second PDCCH in a first cell, the first PDCCH including resource allocation information for a PDSCH of the first cell, the second PDCCH including resource allocation information for a PDSCH of a second cell, the communication method including the steps of: monitoring one or more first PDCCH candidates and one or more second PDCCH candidates in a control resource set; and decoding a first PDCCH candidate of the one or more first PDCCH candidates and a second PDCCH candidate of the one or more second PDCCH candidates, wherein the second PDCCH candidate with a first aggregation level includes multiple CCEs that are shifted, based on a carrier indicator, relative to multiple CCEs constituting the first PDCCH candidate with the first aggregation level, and the second PDCCH candidate with a second aggregation level includes one or more CCEs among the multiple CCEs constituting the second PDCCH candidate with the first aggregation level.

(3) A third aspect of the present invention is a base station apparatus that transmits a first PDCCH and a second PDCCH on a first cell, the first PDCCH including resource allocation information for a PDSCH of the first cell, the second PDCCH including resource allocation information for a PDSCH of a second cell, the base station apparatus including: a USS grasp unit configured to grasp one or more first PDCCH candidates and one or more second PDCCH candidates in a control resource set, the control resource set being configured as a Search space for a terminal apparatus; and a transmitter configured to transmit the first PDCCH by using a first PDCCH candidate of the one or more first PDCCH candidates and transmit the second PDCCH by using a second PDCCH candidate of the one or more second PDCCH candidates, wherein the second PDCCH candidate with a first aggregation level includes multiple CCEs that are shifted, based on a carrier indicator, relative to multiple CCEs constituting the first PDCCH candidate with the first aggregation level, and the second PDCCH candidate with a second aggregation level includes one or more CCEs among the multiple CCEs constituting the second PDCCH candidate with the first aggregation level.

(4) A fourth aspect of the present invention is a communication method used for a base station apparatus that transmits a first PDCCH and a second PDCCH in a first cell, the first PDCCH including resource allocation information for a PDSCH of the first cell, the second PDCCH including resource allocation information for a PDSCH of a second cell, the communication method including the steps of: grasping one or more first PDCCH candidates and one or more second PDCCH candidates in a control resource set, the control resource set being configured as a Search space for a terminal apparatus; and transmitting the first PDCCH by using a first PDCCH candidate of the one or more first PDCCH candidates and transmitting the second PDCCH by using a second PDCCH candidate of the one or more second PDCCH candidates, wherein the second PDCCH candidate with a first aggregation level includes multiple CCEs that are shifted, based on a carrier indicator, relative to multiple CCEs constituting the first PDCCH candidate with the first aggregation level, and the second PDCCH candidate with a second aggregation level includes one or more CCEs among the multiple CCEs constituting the second PDCCH candidate with the first aggregation level.

A program running on the base station apparatus 3 and the terminal apparatus 1 according to an aspect of the present invention may be a program that controls a Central Processing Unit (CPU) and the like, such that the program causes a computer to operate in such a manner as to realize the functions of the above-described embodiment according to an aspect of the present invention. The information handled in these devices is temporarily stored in a Random Access Memory (RAM) while being processed. Thereafter, the information is stored in various types of Read Only Memory (ROM) such as a Flash ROM and a Hard Disk Drive (HDD), and when necessary, is read by the CPU to be modified or rewritten.

Note that the terminal apparatus 1 and the base station apparatus 3 according to the above-described embodiment may be partially achieved by a computer. In that case, this configuration may be realized by recording a program for realizing such control functions on a computer-readable recording medium and causing a computer system to read the program recorded on the recording medium for execution.

Note that it is assumed that the “computer system” mentioned here refers to a computer system built into the terminal apparatus 1 or the base station apparatus 3, and the computer system includes an OS and hardware components such as a peripheral apparatus. Furthermore, the “computer-readable recording medium” refers to a portable medium such as a flexible disk, a magneto-optical disk, a ROM, a CD-ROM, and the like, and a storage apparatus such as a hard disk built into the computer system.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the base station apparatus 3 according to the above-described embodiment may be achieved as an aggregation (apparatus group) including multiple apparatuses. Each of the apparatuses constituting such an apparatus group may include some or all portions of each function or each functional block of the base station apparatus 3 according to the above-described embodiment. The apparatus group is required to have each general function or each functional block of the base station apparatus 3. Furthermore, the terminal apparatus 1 according to the above-described embodiment can also communicate with the base station apparatus as the aggregation.

Furthermore, the base station apparatus 3 according to the above-described embodiment may serve as an Evolved Universal Terrestrial Radio Access Network (EUTRAN). Furthermore, the base station apparatus 3 according to the above-described embodiment may have some or all portions of the functions of a node higher than an eNodeB.

Furthermore, some or all portions of each of the terminal apparatus 1 and the base station apparatus 3 according to the above-described embodiment may be typically achieved as an LSI which is an integrated circuit or may be achieved as a chip set. The functional blocks of each of the terminal apparatus 1 and the base station apparatus 3 may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case where with advances in semiconductor technology, a circuit integration technology with which an LSI is replaced appears, it is also possible to use an integrated circuit based on the technology.

Furthermore, according to the above-described embodiment, the terminal apparatus has been described as an example of a communication apparatus, but the present invention is not limited to such a terminal apparatus, and is applicable to a terminal apparatus or a communication apparatus of a fixed-type or a stationary-type electronic apparatus installed indoors or outdoors, for example, such as an Audio-Video (AV) apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1 (1A, 1B, 1C) Terminal apparatus
3 Base station apparatus
10, 30 Radio transmission and/or reception unit
11, 31 Antenna unit
12, 32 RF unit
13, 33 Baseband unit
14, 34 Higher layer processing unit
15, 35 Medium access control layer processing unit
16, 36 Radio resource control layer processing unit

1. A terminal apparatus that receives a first PDCCH and a second PDCCH in a first cell, the first PDCCH including resource allocation information for a PDSCH of the first cell, the second PDCCH including resource allocation information for a PDSCH of a second cell, the terminal apparatus comprising:
a receiver configured to monitor one or more first PDCCH candidates and one or more second PDCCH candidates in a control resource set; and
a decoding unit configured to decode a first PDCCH candidate of the one or more first PDCCH candidates and a second PDCCH candidate of the one or more second PDCCH candidates, wherein
the second PDCCH candidate with a first aggregation level includes multiple CCEs that are shifted, based on a carrier indicator, relative to multiple CCEs constituting the first PDCCH candidate with the first aggregation level, and
the second PDCCH candidate with a second aggregation level includes one or more CCEs among the multiple CCEs constituting the second PDCCH candidate with the first aggregation level.

2. A communication method used for a terminal apparatus that receives a first PDCCH and a second PDCCH in a first cell, the first PDCCH including resource allocation information for a PDSCH of the first cell, the second PDCCH including resource allocation information for a PDSCH of a second cell, the communication method comprising the steps of:
monitoring one or more first PDCCH candidates and one or more second PDCCH candidates in a control resource set; and
decoding a first PDCCH candidate of the one or more first PDCCH candidates and a second PDCCH candidate of the one or more second PDCCH candidates, wherein
the second PDCCH candidate with a first aggregation level includes multiple CCEs that are shifted, based on a carrier indicator, relative to multiple CCEs constituting the first PDCCH candidate with the first aggregation level, and
the second PDCCH candidate with a second aggregation level includes one or more CCEs among the multiple CCEs constituting the second PDCCH candidate with the first aggregation level.

3. A base station apparatus that transmits a first PDCCH and a second PDCCH on a first cell, the first PDCCH including resource allocation information for a PDSCH of the first cell, the second PDCCH including resource allocation information for a PDSCH of a second cell, the base station apparatus comprising:
a USS grasp unit configured to grasp one or more first PDCCH candidates and one or more second PDCCH candidates in a control resource set, the control resource set being configured as a Search space for a terminal apparatus; and
a transmitter configured to transmit the first PDCCH by using a first PDCCH candidate of the one or more first PDCCH candidates and transmit the second PDCCH by using a second PDCCH candidate of the one or more second PDCCH candidates, wherein the second PDCCH candidate with a first aggregation level includes multiple CCEs that are shifted, based on a carrier indicator, relative to multiple CCEs constituting the first PDCCH candidate with the first aggregation level, and
the second PDCCH candidate with a second aggregation level includes one or more CCEs among the multiple CCEs constituting the second PDCCH candidate with the first aggregation level.

4. A communication method used for a base station apparatus that transmits a first PDCCH and a second PDCCH in a first cell, the first PDCCH including resource allocation information for a PDSCH of the first cell, the second PDCCH including resource allocation information for a PDSCH of a second cell, the communication method comprising the steps of:
grasping one or more first PDCCH candidates and one or more second PDCCH candidates in a control resource set, the control resource set being configured as a Search space for a terminal apparatus; and
transmitting the first PDCCH by using a first PDCCH candidate of the one or more first PDCCH candidates and transmitting the second PDCCH by using a second PDCCH candidate of the one or more second PDCCH candidates, wherein
the second PDCCH candidate with a first aggregation level includes multiple CCEs that are shifted, based on a carrier indicator, relative to multiple CCEs constituting the first PDCCH candidate with the first aggregation level, and
the second PDCCH candidate with a second aggregation level includes one or more CCEs among the multiple CCEs constituting the second PDCCH candidate with the first aggregation level.
